(19) United States
(12) Patent Application Publication
(10) Pub. No.: US 2018/0365764 A1
(43) Pub. Date: Dec. 20, 2018

(54) SOLO-PARTY COLLATERALIZED LIQUIDITY

(71) Applicant: SWEETBRIDGE, SCOTTSDALE, AZ (US)

(72) Inventor: J. SCOTT NELSON, SCOTTSDALE, AZ (US)

(73) Assignee: SWEETBRIDGE, SCOTTSDALE, AZ (US)

(21) Appl. No.: 16/009,856

(22) Filed: Jun. 15, 2018

Related U.S. Application Data
(60) Provisional application No. 62/520,201, filed on Jun. 15, 2017.

(51) Int. Cl. G06Q 40/02; G06Q 20/06; H04L 9/06

(52) U.S. Cl. CPC G06Q 40/025; H04L 9/0637; G06Q 20/065

(57) ABSTRACT

A processor may lock an asset in a blockchain-based database in communication with the processor. The locking may include establishing a locked asset value for the asset and preventing exchange of the asset by an asset owner. The processor may generate a loan value for the asset less than the locked asset value. The processor may record the loan value in the blockchain-based database. The processor may transmit a loan asset having the loan value to the asset owner.

### CROSS-REFERENCE TO RELATED APPLICATION

This application is based on and derives priority from U.S. Provisional Patent Application No. 62/520,201, filed Jun. 15, 2017, the entire contents of which are incorporated by reference herein.

### BRIEF DESCRIPTION OF THE FIGURES

FIG. 1 shows a network according to an embodiment of the present disclosure.

FIG. 2 shows a server device according to an embodiment of the present disclosure

FIGS. 3A-3B show cryptocurrency behaviors according to an embodiment of the present disclosure.

FIGS. 4A-4C show exchange event examples according to an embodiment of the present disclosure.

FIG. 5 shows an asset management process according to an embodiment of the present disclosure.

FIGS. 6A-6H show a plurality of mathematical equations related to the systems and methods of FIGS. 1-5 according to an embodiment of the present disclosure.

### DETAILED DESCRIPTION OF SEVERAL EMBODIMENTS

A supply chain may include everything that produces, moves, stores, and/or reports on a product or service in commerce. Embodiments disclosed herein may provide a blockchain-based protocol stack that may enable highly efficient supply chains and commerce without intermediaries. The protocol stack may solve at least four basic problems:
1. Lack of liquidity in supply chains, by creating an innovative collateralized liquidity economy;
2. Resource underutilization, by enabling asset sharing across organizational boundaries;
3. Suboptimal supply chain operations, by providing access to liquid professional talent and creating incentives for supply chain professionals to provide services based on objective measurements of outcomes;
4. Accelerating pace and scale of change, by creating more flexible and adaptive supply chains.

According to some embodiments, if there is value in one or more assets held by an organization, it may be possible to represent this value in a liquid currency without resorting to intermediary services. Some embodiments may use blockchain technology to make this possible. These embodiments may use blockchain technology to create custom decentralized economic systems complete with their own rules for minting and transacting currency. In some embodiments, the blockchain may remove the need for expensive and inefficient centralized lending services.

Some embodiments may allow holders of blockchain-based assets and/or assets recordable on a blockchain to maintain their ownership of the assets while at the same time accessing disposable capital issued against the assets. This may be achieved using Asset Vault smart contracts and an issuance process called a UOU (You Owe You). This smart contract may issue a stable cryptocurrency when collateral, or evidence of ownership thereof (e.g., for physical collateral), is deposited and locked on the blockchain. When the loan is repaid, the collateral may be returned under the control of the owner and the associated stable cryptocurrency will be removed from circulation. Collateral may include any item of value that can be managed on blockchain. Examples may include, but are not limited to, cryptocurrencies or other transferrable cryptoassets, transferrable stakes in other smart contracts, or real-world physical assets whose ownership can be tracked on blockchain in a legally enforceable way.

Some embodiments may use two cryptographic digital tokens, labeled herein as Bridgecoin and Sweetcoin. Bridgecoin may be an asset whose value is pegged to fiat currency or some other external value indicator. Sweetcoin may be issued in limited supply and may be used as a discount token in the ecosystem. For example, Sweetcoin may be treated by the system as a coupon that gives its holders the right to receive valuable services at a discount or free of charge.

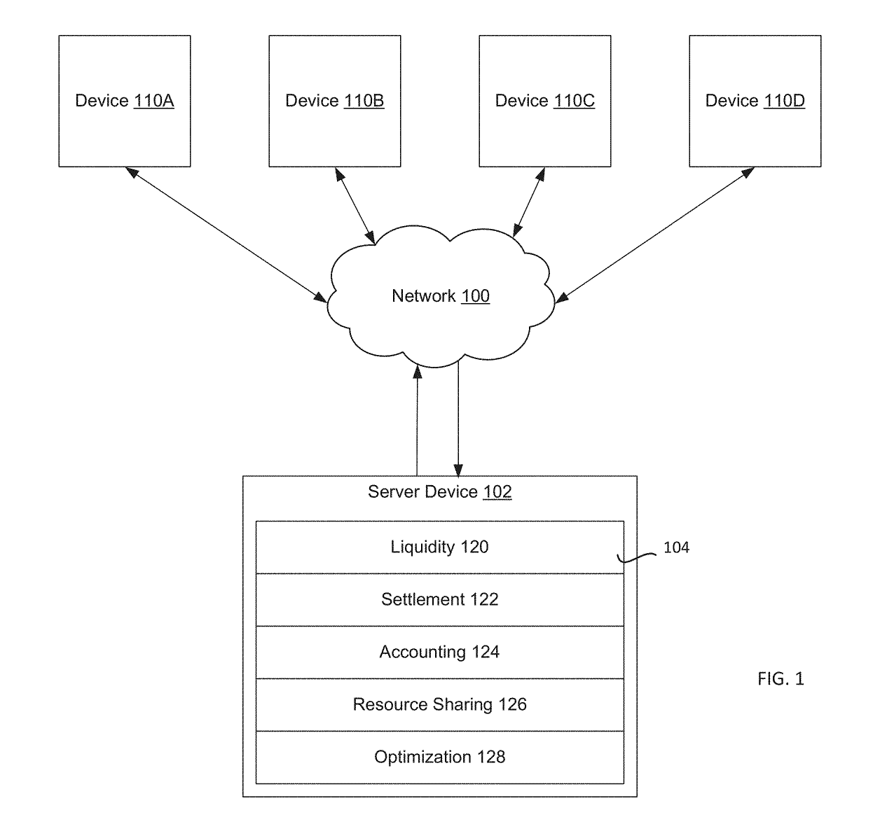

FIG. 1 shows a network 100 according to an embodiment of the present disclosure. Network 100 may include and/or provide access to server device 102, which may be configured to provide the disclosed protocol stack 104. Network 100 may include any network(s) (e.g., the Internet or another public and/or private network). Devices 110, which may be any computing devices, may be able to communicate with server device 102 to access protocol stack 104 services and/or process distributed blockchain data as described below.

Server device 102 may be a server or other computing device configured to perform processing associated with protocol stack 104 as described below. Protocol stack may include multiple layers, such as liquidity protocol 120, settlement protocol 122, accounting protocol 124, resource sharing protocol 126, and/or optimization protocol 128. Server device 102 is depicted as a single server including a single protocol stack 104 for ease of illustration, but those of ordinary skill in the art will appreciate that server device 102 may be embodied in different forms for different implementations. For example, server device 102 may include a plurality of servers.

Liquidity protocol 120 may allow users to borrow money against assets they already own without using the services of a lender. Liquidity protocol 120 may decrease the time required for any entity to convert assets, such as accounts receivable, real estate, inventory, equipment, and commodities into cash. Liquidity protocol 120 may provide smart contracts that may enable automated money supply management, implementation of specialized accounting rules, and/or a variety of pre-programmed behaviors associated with economic tokens. Liquidity protocol 120 may use token cryptoeconomics to replace banking services while providing access to low cost liquidity.

Liquidity protocol 120 may create an economy based on two digital tokens, Bridgecoin and Sweetcoin. Bridgecoin may be a stable cryptocurrency used as an easily accessible liquid transaction currency by participants, as described in detail below. Bridgecoin may be a cash-like asset that may be exchanged for fiat currency. Bridgecoin may be issued using a participant-level smart contract, labeled herein as an Asset Vault, in exchange for a broad range of valuable collateral assets deposited by the participant. When Bridgecoin is repaid to the Asset Vault, the collateral may be unlocked for withdrawal, at which point the participant may regain custody of the asset and the associated Bridgecoin may be burnt and removed from circulation. In some embodiments, a small fee may be assessed by server device 102 for this service. This process may serve a purpose similar to asset-backed bank loans, but with no intermediary.

The second token, Sweetcoin, may serve as a software license that may reduce liquidity fees for its holders, allowing them to use the system to borrow money, make settlements, and/or convert to and from fiat currency without cost. When Sweetcoin is added to a collateral portfolio and activated, the small fee that Sweetbridge otherwise charges to issue Bridgecoin may be reduced or eliminated. Activating a sufficient amount of Sweetcoin may allow one to take loans that are completely interest-free, as described in detail below. Supply chain participants may use this token system to generate cheap liquidity on demand, while maintaining ownership and use of their assets. Sweetbridge may enable high liquidity and may accept a broad range of assets as collateral.

Settlement protocol 122 may utilize liquidity created by liquidity protocol 120. Settlement protocol 122 may define ways in which supply chain participants may transact with one another. Settlement protocol 122 may be compared to TCP/IP, the protocol that governs the digital packet transmission layer of the Internet. Similar to Internet data packet routing standards, settlement protocol 122 may provide standards for settlement and provision of goods and services. Settlement protocol 122 may enable global optimization of supply chains through efforts of local actors. Settlement protocol 122 may reduce or eliminate settlement risk caused by the failure of one party to pay another party. Settlement protocol 122 may achieve this by rerouting payments otherwise owed by a defaulting party to cover losses caused by that party. In other words, settlement protocol 122 may route payment around the defaulting party like the Internet routes a packet around a failed router.

Settlement protocol 122 may provide transparency into changes in the financial state of participating entities as well as reputational and historic information. Settlement protocol 122 may model existing trust relationships, allow resource sharing, and/or generate data used for accounting and risk-management.

In some embodiments, Bridgecoin generated by liquidity protocol 120 may be the native transaction currency for settlement protocol 122 may, but settlement protocol 122 may also accept other means of monetary exchange, such as fiat or cryptocurrencies. For example, server device 102 may provide public exchange services that may allow participants to convert fiat or cryptocurrencies into Bridgecoin.

Accounting protocol 124 may use the information generated by settlement protocol 122 to provide transparency into changes in the financial strength of supply chain participants. Accounting protocol 124 may provide transparency by giving organizations a detailed view into their own economics and financing capacity. Accounting protocol 124 may provide risk management by independently assessing financial risks associated with any specific entity, similar to a credit score. Accounting protocol 124 may provide auditability through a detailed, permanent audit trail of all transactions completed. Risk assessments enabled by accounting protocol 124 may improve the safety of transactions and increase the economic efficiency of supply chains.

Accounting protocol 124 may provide transparency into the value entities generate. Consequently, future value may become a type of collateral on par with other assets, by virtue of having known risk and volatility. Using this collateral to create liquidity may provide additional working capital required for supply chain companies to grow and expand. Accounting protocol 124 may reasonably estimate and risk manage future value of an organization when all of its transactions are available within server device 102 memory for a sufficiently long period of time.

Resource sharing protocol 126 may use data generated by liquidity protocol 120, settlement protocol 122, and/or accounting protocol 124. Resource sharing protocol 126 may allow supply chain entities to generate additional profit through collaborative use of shared resources such as factories, warehouses, and heavy equipment.

Optimization protocol 128 may provide tools, APIs, and/or data aggregation which may facilitate the analysis of supply chain networks that may reward supply chain professionals in the market on a contingency basis by objectively measuring the outcomes from their efforts.

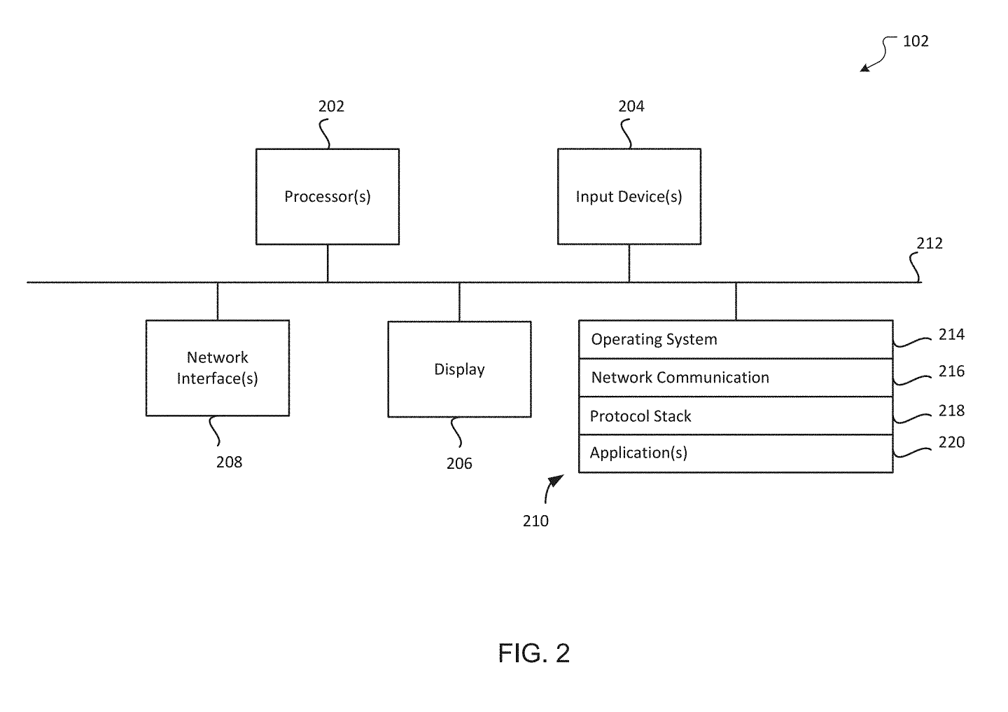

FIG. 2 is a block diagram of an example server device 102 that may implement various features and processes as described herein. The server device 102 may be implemented on any electronic device that runs software applications derived from compiled instructions, including without limitation personal computers, servers, smart phones, media players, electronic tablets, game consoles, email devices, etc. In some implementations, the server device 102 may include one or more processors 202, one or more input devices 204, one or more display devices 206, one or more network interfaces 208, and one or more computer-readable mediums 210. Each of these components may be coupled by bus 212.

Display device 206 may be any known display technology, including but not limited to display devices using Liquid Crystal Display (LCD) or Light Emitting Diode (LED) technology. Processor(s) 202 may use any known processor technology, including but not limited to graphics processors and multi-core processors. Input device 204 may be any known input device technology, including but not limited to a keyboard (including a virtual keyboard), mouse, track ball, and touch-sensitive pad or display. Bus 212 may be any known internal or external bus technology, including but not limited to ISA, EISA, PCI, PCI Express, NuBus, USB, Serial ATA or FireWire. Computer-readable medium 210 may be any medium that participates in providing instructions to processor(s) 202 for execution, including without limitation, non-volatile storage media (e.g., optical disks, magnetic disks, flash drives, etc.), or volatile media (e.g., SDRAM, ROM, etc.).

Computer-readable medium 210 may include various instructions 214 for implementing an operating system (e.g., Mac OS®, Windows®, Linux). The operating system may be multi-user, multiprocessing, multitasking, multithreading, real-time, and the like. The operating system may perform basic tasks, including but not limited to: recognizing input from input device 204; sending output to display device 206; keeping track of files and directories on computer-readable medium 210; controlling peripheral devices (e.g., disk drives, printers, etc.) which can be controlled directly or through an I/O controller; and managing traffic on bus 212. Network communications instructions 216 may establish and maintain network connections (e.g., software for implementing communication protocols, such as TCP/IP, HTTP, Ethernet, telephony, etc.).

Protocol stack instructions 218 may include instructions that perform processing associated with the various protocol layers as described herein. Application(s) 220 may be an application that uses or implements the processes described herein and/or other processes. The processes may also be implemented in operating system 214.

The described features may be implemented in one or more computer programs that may be executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program may be written in any form of programming language (e.g., Objective-C, Java), including compiled or interpreted languages, and it may be deployed in any form, including as a stand-alone program or as a module, component, subroutine, or other unit suitable for use in a computing environment.

Suitable processors for the execution of a program of instructions may include, by way of example, both general and special purpose microprocessors, and the sole processor or one of multiple processors or cores, of any kind of computer. Generally, a processor may receive instructions and data from a read-only memory or a random access memory or both. The essential elements of a computer may include a processor for executing instructions and one or more memories for storing instructions and data. Generally, a computer may also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data may include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory may be supplemented by, or incorporated in, ASICs (application-specific integrated circuits).

To provide for interaction with a user, the features may be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features may be implemented in a computer system that includes a back-end component, such as a data server, or that includes a middleware component, such as an application server or an Internet server, or that includes a front-end component, such as a client computer having a graphical user interface or an Internet browser, or any combination thereof. The components of the system may be connected by any form or medium of digital data communication such as a communication network. Examples of communication networks include, e.g., a telephone network, a LAN, a WAN, and the computers and networks forming the Internet.

The computer system may include clients and servers. A client and server may generally be remote from each other and may typically interact through a network. The relationship of client and server may arise by virtue of computer programs running on the respective computers and having a client-server relationship to each other.

One or more features or steps of the disclosed embodiments may be implemented using an API. An API may define one or more parameters that are passed between a calling application and other software code (e.g., an operating system, library routine, function) that provides a service, that provides data, or that performs an operation or a computation.

The API may be implemented as one or more calls in program code that send or receive one or more parameters through a parameter list or other structure based on a call convention defined in an API specification document. A parameter may be a constant, a key, a data structure, an object, an object class, a variable, a data type, a pointer, an array, a list, or another call. API calls and parameters may be implemented in any programming language. The programming language may define the vocabulary and calling convention that a programmer will employ to access functions supporting the API.

In some implementations, an API call may report to an application the capabilities of a device running the application, such as input capability, output capability, processing capability, power capability, communications capability, etc.

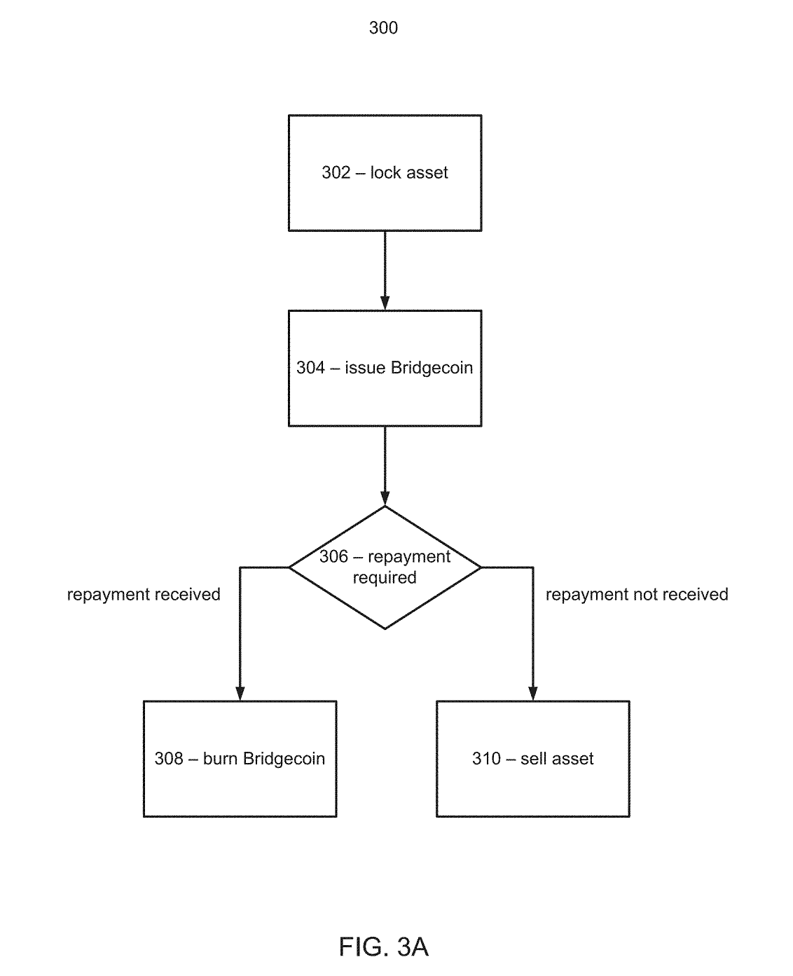

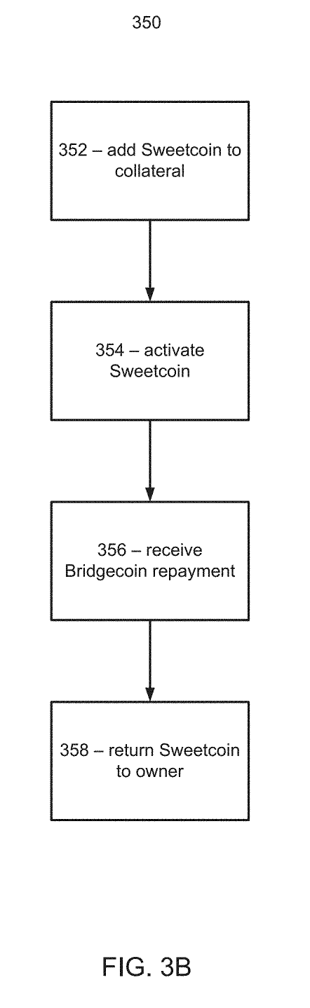

FIGS. 3A-3B show cryptocurrency behaviors according to an embodiment of the present disclosure. As noted above, protocol stack 104 may utilize at least two cryptocurrencies, Bridgecoin and Sweetcoin, to provide various features noted above and described in greater detail below. Accordingly, an understanding of the cryptocurrencies may be useful for understanding the specific processing behind the features.

In the liquidity system provided by protocol stack 104, participants may exchange collateral for liquidity in the form of a cryptocurrency specific to the protocol stack 104 economy. This currency, Bridgecoin, may serve as a means of transacting along the supply chain.

Bridgecoin may maintain a stable peg to a fiat currency such as the US dollar and/or to a commodity, although in various embodiments, Bridgecoin may be pegged to any value indicator. This stability may be ensured by one or more of the following factors:
Collateral may be denominated according to the fiat denomination (e.g., in USD), and Bridgecoin may be issued in the amount equal to the USD value of the usable portion of collateral. To unlock the collateral, Bridgecoin may be repaid in the amount equal to that which was originally withdrawn. Because of this, price moves of Bridgecoin may drive incentives for participants to either deposit collateral or withdraw existing collateral depending on whether Bridgecoin trades above or below its par value with USD.
Incentives may exist for specialized treasury entities (e.g., market makers) to contribute assets for creating an additional supply of Bridgecoin when needed or to sell assets to buy Bridgecoin when supply exceeds demand.
Parties who have excess capital may contribute the excess capital for a portion of the total fees received from users for generating liquidity. Such parties may take on risk by offering their currency holdings in exchange for Bridgecoin at par value, but may receive a portion of network fees in return. At periods of high Bridgecoin supply, the network may generate higher fees to incentivize Bridgecoin redemption.
Assets that have dropped too far in value may be sold on the open market for Bridgecoin at par value and, in some embodiments, may incur a penalty to be paid by the original owner due to the liquidation event.

FIG. 3A illustrates a Bridgecoin transaction process 300. Liquidity protocol 120 may issue, maintain, and/or destroy Bridgecoins according to process 300, for example when protocol stack 104 provides services described below that use Bridgecoins.

Process 300 may involve issuing Bridgecoins against collateral (e.g., as UOUs). The collateral may be held until the Bridgecoins are repaid or, in the event of a significant loss in collateral value or failure to repay in time, may be sold. Bridgecoins may be issued for many different types of collateral, even some types that cannot be used to guarantee traditional loans. Examples may include, but are not limited to, the following:
Cryptocurrencies and/or other cryptoassets
Physical assets such as real estate, heavy equipment, physical commodities, etc.
Conventional currencies and financial instruments such as stocks, bonds, loan guarantees, etc.
Future cash flows such as accounts receivables, outstanding invoices, etc.
Future products and/or services
Time, including valuable work time pledged by a professional or a team
Intellectual property

Different types of collateral may pose different risks and require a different set of procedures. Different types of collateral may be represented digitally on the blockchain using smart contracts specific to the respective collateral types. Examples may include, but are not limited to, the following:
Cryptocurrencies are already digital blockchain assets, but their risk profiles and volatility levels may differ. When liquidity protocol 120 onboards additional cryptocurrencies, it may measure and specify these parameters.
Discrete physical assets (e.g., heavy equipment, real estate) and financial assets (e.g., cash, stocks) may be onboarded by creating legal technology stipulating that ownership and custody may be recorded on blockchain. In this form, asset ownership and custody may be controlled by a smart contract, such as the Asset Vault. In general, any legal obligation may be digitized in this way and consequently used as collateral to generate liquidity and fund transactions.
Non-discrete assets (e.g. accounts receivable, inventory, commodities, factory capacity, time) may also be digitized as blockchain assets, provided that an entity transacts exclusively through server device 102, and additional risk management mechanisms are available (e.g., Sweetcoin, as described below).

At 302, liquidity protocol 120 may receive an asset from an owner and lock the asset. The process of creating liquidity through collateral may begin when a valuable asset is locked into a blockchain smart contract called an Asset Vault. The Asset Vault may take possession of the collateral for the period of time that it is locked. Accordingly, liquidity protocol 120 may perform any Blockchain recordation processing available in the art to create an immutable ledger entry establishing possession of the asset.

At 304, liquidity protocol 120 may issue a Bridgecoin. In exchange for the collateral, liquidity protocol 120 may issue Bridgecoin(s) to the owner. In some embodiments, liquidity protocol 120 may issue Bridgecoin(s) up to a maximum amount set as a percentage of the locked collateral value. This percentage may differ by collateral type and may be based on risk assessment and volatility inherent to the asset. Example algorithms for determining Bridgecoin value to issue are given below.

At 306, liquidity protocol 120 may determine that repayment of the issued Bridgecoin(s) is due. For example, in some cases, users may be required repay the liquidity they received from the collateral vault within a specified amount of time. The amount repaid, the liability, may be slightly higher than the liquidity generated based on an associated interest agreed upon during the inception of the loan. This may ensure that the operation and maintenance of the system are economically well-supported. The additional liability may also incentivize responsible use of the system at a fraction of the cost of traditional interest rates. In other example cases, certain types of collateral such as cryptocurrencies or stocks may significantly fluctuate in value. Liquidity protocol 120 may monitor one or more network 100 sources of collateral value data (e.g., stock and/or currency market exchanges) to detect changes in collateral value. In such cases, when the value of the collateral in the vault drops below a certain threshold called the notice line, server device 102 may notify the user that they are approaching the point where their assets are at risk of being sold. To address this, the user may contribute additional collateral to the Asset Vault or pay down their liability with Bridgecoin to make up the difference.

If repayment is received in a timely fashion, at 308, liquidity protocol 120 may burn (e.g., destroy) the issued Bridgecoin. Burning a coin may remove it from circulation and thus may reduce the number of Bridgecoins in the market, maintaining a balance between collateral and Bridgecoin and ensuring the stability of the asset-backed cryptocurrency.

If the value of the collateral drops further, and/or if the necessary assets or funds are not contributed in time, at 310, liquidity protocol 120 may sell all or a portion of the collateral and may assess a penalty incurred by the original owner. The threshold below which the value of the collateral indicates a required sale, called the sell line, may be set differently for different collateral asset types depending on their risk and volatility parameters, as described in detail below. Users may be allowed to set their sell line at any value above a required minimum. This may prevent correlated large scale sell events that could otherwise introduce instability into the system.

FIG. 3B illustrates a Sweetcoin transaction process 350. Liquidity protocol 120 may utilize Sweetcoins according to process 350, for example when protocol stack 104 provides services described below that use Sweetcoins. For example, Sweetcoin may be used to change the risk profile and repayment schedule of the collateral pool that uses it. Sweetcoin may be a limited supply cryptocurrency, such that no additional Sweetcoin may be created after an initial token generation event.

At 352, liquidity protocol 120 may add Sweetcoin from a user to a set of collateral (e.g., collateral locked at 302). At 354, liquidity protocol 120 may activate the Sweetcoin. When Sweetcoin is activated, the liabilities a user has to repay may be reduced. Depending upon the amount of Sweetcoin activated, the borrowing fees and/or other fees incurred may even become zero, allowing participants to create liquidity free of fees. In some embodiments, activating Sweetcoin may allow a slightly higher collateral advance to be made available. This may encourage users to buy Sweetcoin and use it to create more liquidity from their existing assets.

At 356, liquidity protocol 120 may determine that the outstanding Bridgecoin has been repaid (e.g., at 308). At 358, when the outstanding Bridgecoin is repaid, liquidity protocol 120 may return the Sweetcoin to the owner in the same amount as initially deposited.

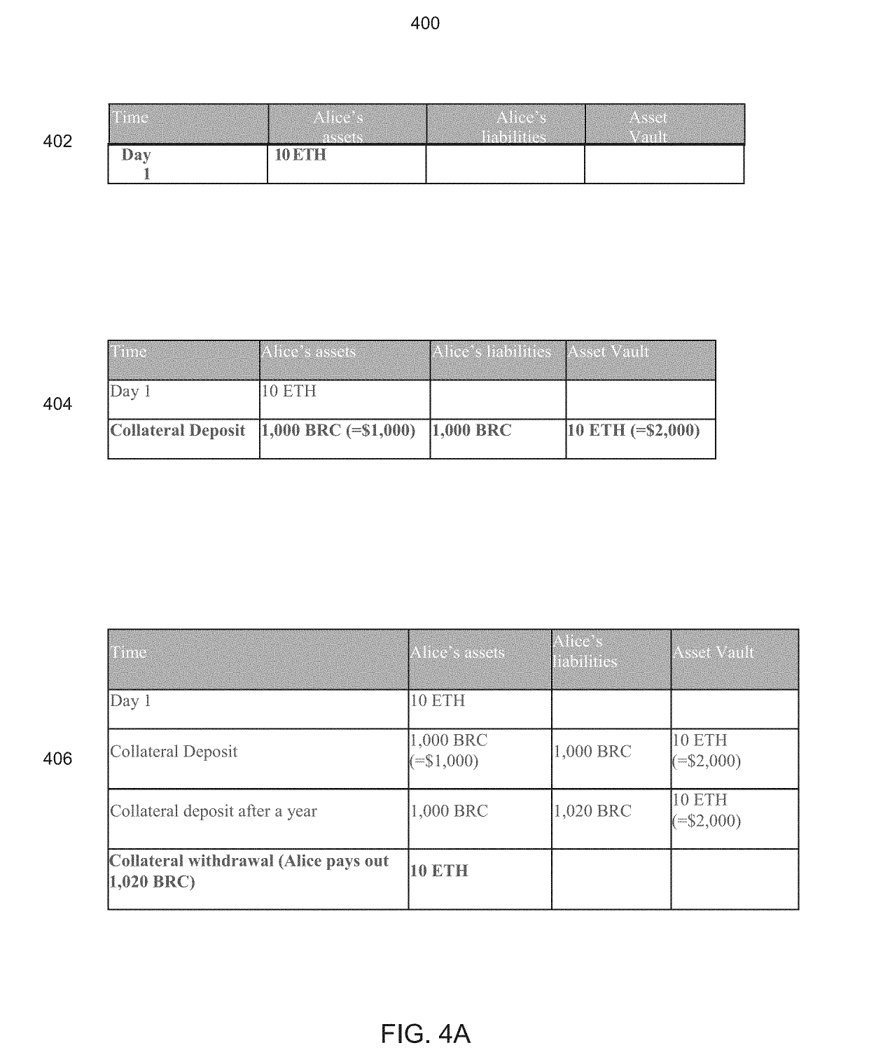

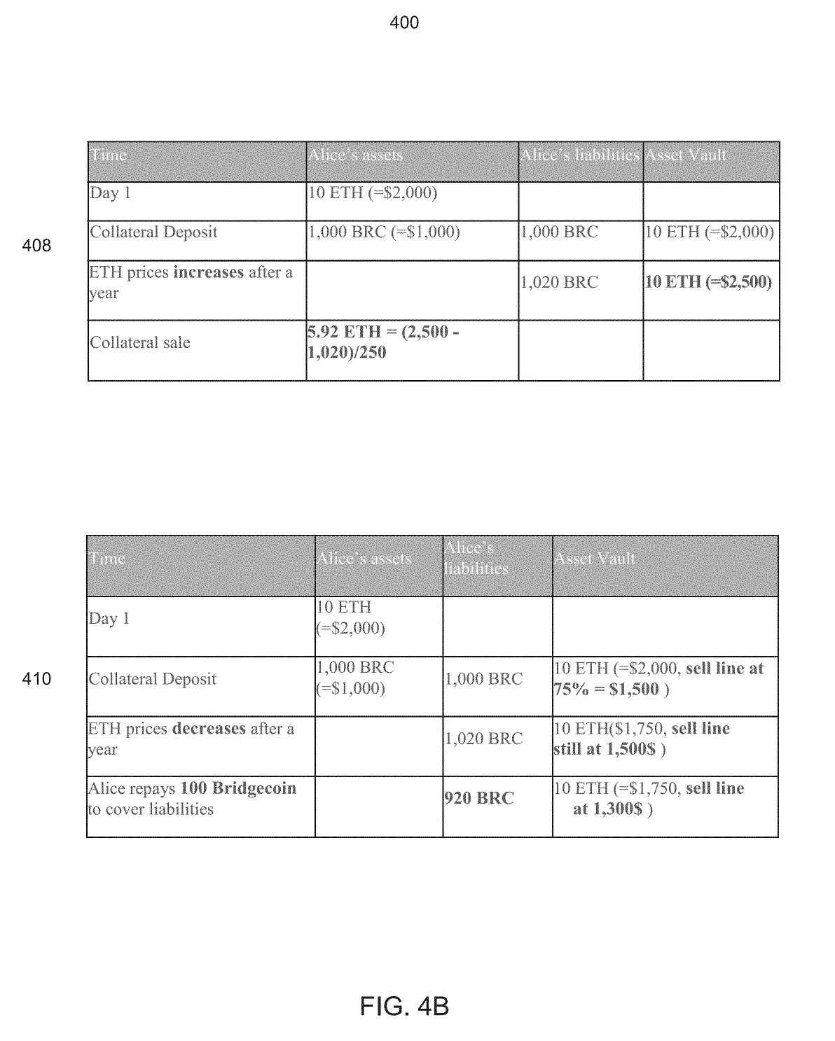

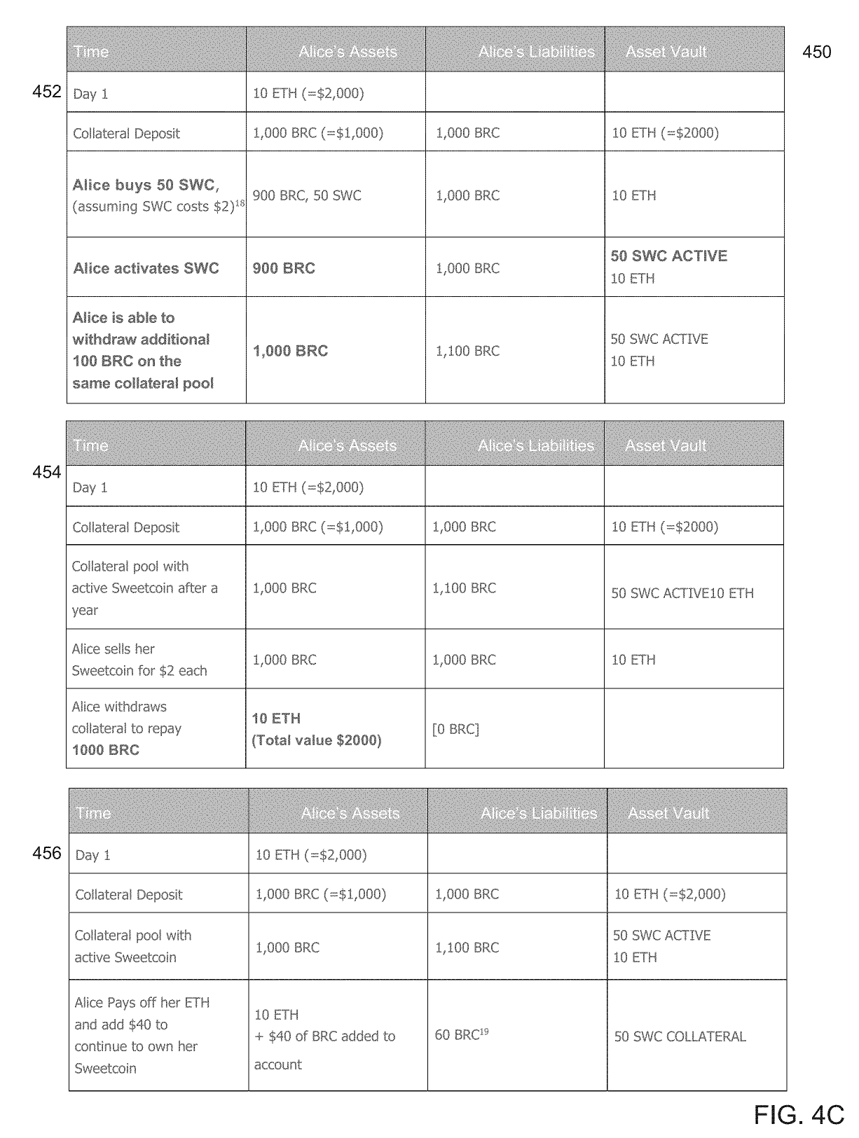

FIGS. 4A-4C show exchange event examples 400 and 450 according to an embodiment of the present disclosure. These are scenarios involving Bridgecoin and Sweetcoin transactions as described in FIGS. 3A-3B. The examples 400 and 450 are illustrative only, and it will be appreciated that a variety of collateral and/or coin exchange patterns may be possible.

Alice is an early token holder of Ether (ETH) and believes in the long-term value ETH. Alice wants to buy a new computer, but she doesn't want to dip into her USD sayings or sell her ETH in order to purchase the computer. Assume Alice has 10 ETH and the current value of ETH is $200. First table 402 illustrates the economic value of Alice's assets in multiple buckets (time, assets, liabilities, and vault).

Server device 102 may allow Alice to create liquidity by depositing her Ether into a smart contract (the Asset Vault) and receiving Bridgecoin in exchange to its collateralization. Alice's ETH may be managed by the Asset Vault smart contract into which she deposited her funds. Assuming ETH collateralization ratio of 50%, Alice may deposit 10 ETH and receive up to 1,000 BRC (Bridgecoin) in exchange (total value of Ether being $2,000, Alice receives 50% of that in Bridgecoin). This is shown in second table 404.

If Alice borrows the money for a year, her liability becomes 1,020 BRC, the original 1,000 BRC of created liquidity plus a small excess liability of 2% if she repays the Bridgecoin exactly one year later. Liquidity fees may be like interest in that the length of time may determine their size. At this point, Alice may spend her Bridgecoin to buy goods or exchange them for other currency.

When the deposit period (e.g., one year) elapses. Alice may need to repay her liabilities to unlock her Ether collateral (principal+fees). This is shown in third table 406. We assume here that the price of Ether remains stable for simplicity. As Alice unlocks her assets from the vault, the Bridgecoins that were used to pay the principal amount may be burned and removed from circulation, while the Bridgecoins that were used to pay for the fees may be directed to an economy stability pool to further stabilize the economy.

Alternatively, Alice may withdraw a part of the ETH held in the vault to repay her liabilities, as shown in fourth table 408. Alice may sell part of her ETH, exchange it for Bridgecoin, and use the Bridgecoin to repay her outstanding liabilities. This may make sense if her ETH price has increased while Alice held the ETH in the Asset Vault, for example (e.g., in fourth table 408, ETH price is now $250).

If, however, the price of Ether drops, then some collateral may be sold by server device 102 to maintain stability. Assuming that a sell line for ETH is set at 75%, some of Alice's collateral may be sold when the value of her ETH falls below 51.500 (75% of $2,000 of the Restricted Asset value). First, server device 102 may send Alice a notice (e.g., email and/or in-app notification) based on Alice's predefined notice line. Then, once the Sell Line is passed, server device 102 may send another notification to Alice recommending that Alice repay some of her liabilities (e.g., with BRC) or increase her assets in the vault (e.g., with additional ETH or other assets) with a specific deadline (e.g., 6 hours) by which she must rectify her vault from its “Invalid” state, otherwise a portion of her collateral may be sold. If Alice does not take the recommended measures, server device 102 may buy a portion of the defaulted Asset Vault and charge Alice a penalty fee in order to return it to a “Good” state.

Assuming that Alice repays her liabilities, the situation may be as shown in fifth table 410. If, however, Alice chooses to wait and the price of Ether drops even further, the server device 102 may act in order to maintain the economy's stability. In this case, assets may be purchased up to the specific amount of collateral that brings the account back to compliance, plus a penalty fee and/or exchange fee in some embodiments.

Now assume Alice wants to make better use of her funds. When Sweetcoin is activated in the vault, server device 102 may reduce Alice's liabilities automatically. Additionally, Sweetcoin activation may cause an increase in the collateralization ratio of assets so Alice could borrow more if she wanted. This is shown in sixth table 452.

While it appears that Alice's liabilities have increased for the same amount of liquidity, Alice now has 50 Sweetcoin (SWC) in her vault in addition to 10 ETH. Seventh table 454 shows what happens assuming that the Sweetcoin market price doesn't change. By using Sweetcoin, Alice created liquidity of 1,000 BRC for her own use at no cost. This scenario assumes that neither the price of ETH nor of SWC has increased. Alice's benefit may be higher if either of these assets appreciated while being held in the vault.

Alice may sell her Sweetcoin, or she may invest $40 and use it as collateral for an interest-free loan for five years while retaining ownership of it, as shown in eighth table 456. This way, if SWC appreciates, Alice may retain the ability to profit from reselling it at a higher price, but has only spent $40 dollars to have a $100 investment in Sweetcoin.

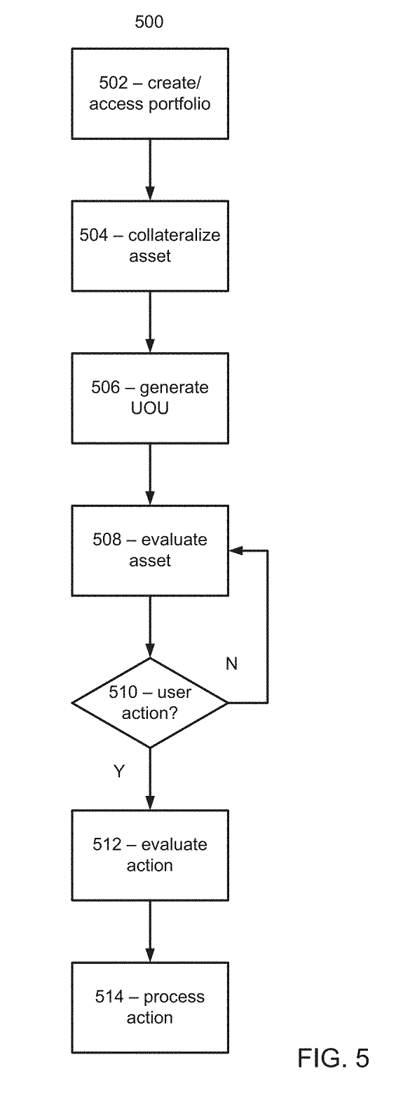

FIG. 5 shows an asset management process 500 according to an embodiment of the present disclosure. Server device 102 may perform process 500 to collateralize assets, generate coins, and manage assets and coins in a manner consistent with, but not limited to, the examples described above. For example, server device 102 may perform process 500 in response to user interactions with server device 102 through network 100 and/or in response to market changes or other inputs detected by server device 102.

At 502, server device 102 may create and/or access a user's portfolio. A portfolio may be a smart contract container for any type of collateral (also known as a Vault or Balance Sheet). The portfolio may allow users to generate BRC by creating UOUs (liabilities against the portfolio). The user accessing the portfolio may be a person with assets interested in collateralizing the assets against the ability to generate UOUs and BRC as a result. In return the user may “lock” the assets within the portfolio and may be unable to use them for any other purpose as long as there is a UOU against them. Once the user is interested in withdrawing them for a different purpose, server device 102 may require the user to repay to the portfolio the same amount of BRC he originally lent, as described below. Users may also be provided an ability to reduce fees that are associated with the system. For that, the user may activate SWC as described below.

For example, server device 102 may receive a portfolio creation or login request from a remote device 110 through network 100. Server device 102 may create a portfolio for a user if no portfolio exists, or access the portfolio associated with a user login. In some embodiments, server device 102 may perform identity verification (e.g., a know your customer (KYC) process) for a user attempting to create a portfolio for a first time. In some embodiments, a user may have multiple portfolios, and the request may identify a particular portfolio. Each portfolio may hold, or may be configured to hold, one or more types of collateral.

At 504, server device 102 may collateralize an asset. Collateralizing the asset may include adding asset information to the portfolio, thereby enabling the asset to be identified as collateral for UOUs. In order for server device 102 to generate a UOU, the portfolio may contain assets and may remain in compliance (e.g. liabilities value/assets value>sell line). Any asset in the portfolio may be considered to be collateral. Server device 102 may collateralize an asset without taking a UOU against it, which may maintain a margin for volatility and avoid causing the portfolio's value to drop below the sell line.

To collateralize an asset, server device 102 may register the asset in a journal which maintains the state of the asset and its legal ownership while holding the asset within the blockchain smart contract (the portfolio). Server device 102 may establish one or more economy settings for the collateralized asset, which may include, but are not limited to, the following:
The collateralization ratio for each asset
The interest rate on UOU collateralized by a specific asset
The exchange fee in %
The sell line penalty
The sell line in % of liability*collateralization ratio
A default notice line as a % of the sell line

At 506, server device 102 may generate a UOU. For example, to generate the UOU, server device 102 may lock an asset in the blockchain smart contract, the locking including establishing a locked asset value for the asset and preventing exchange of the asset by the asset owner, generating a loan value for the asset less than the locked asset value, recording the loan value in the blockchain smart contract, and giving a loan asset having the loan value to the asset owner.

When a user wants to create a new UOU, server device 102 may evaluate the request to ensure that the portfolio is in compliance. For example, UOU creation may be permitted in a portfolio if the collateral is sufficient for the requested amount of BRC (e.g., the loan value). This means that the portfolio may remain in compliance based on the collateralization ratio and sell line (e.g., liability value (LV)/asset value (AV)>sell line), where AV is computed by multiplying the current price by the number of tokens and then by the collateralization ratio, LV is computed by summing up all the minted BRC and the incurred fees minus the BRC repaid, and sell line is a percentage (e.g., 75%, which means that for a liability of 100 the asset value may never fall below 75 or the liquidation process will be initiated). If the portfolio is in compliance, server device 102 may lock the asset and deliver the BRC to the user.

In some embodiments, server device 102 may evaluate the request based on a BRC amount included in the request. In other embodiments, server device 102 may determine a value of the collateral (e.g., by checking a market listing or other value source available through network 100 for the collateral's value) and offer a BRC amount less than or equal to the collateral's value as a maximum BRC available.

Server device 102 may lock the asset in the blockchain smart contract by creating and/or placing a digital token representing a real asset into the blockchain smart contract. The contract may be signed by the user's key and/or a key held by server device 102.

At 508, server device 102 may evaluate the asset. For example, while an asset is locked, server device 102 may repeatedly check the value of the asset, as the asset's true (e.g., market) value may vary independently of the value at which it was locked. Server device 102 may periodically value assets within a portfolio to determine whether the portfolio remains above the sell line, as portfolios dropping below the sell line may require user contribution of additional funds and/or sale of a portion of the assets locked therein.

Server device 102 may determine the value of the assets by checking a market listing or other reliable value source available through network 100 for the collateral's value (e.g., coin market cap, cryptocompare.com, Uphold, Yahoo Finance, etc.). Server device 102 may perform the check at regular intervals (e.g., every 15 minutes) in some embodiments. In some embodiments, server device 102 may evaluate the sell line for an asset by multiplying each asset's quantity by its current value and, if there are multiple asset types, summing the amounts in order to obtain the asset value. Server device 102 may determine whether Asset Value<Total Liability*Collateralization Ratio*Sell Line and, if so, server device 102 may notify the user. The user may contribute more value to the portfolio to bring it above the sell line, or server device 102 may sell some assets to reduce the total liability. For example, a portion of the assets may be sold and used to repay part of the liabilities in order to maintain the vault in compliance. In some embodiments, when assets are sold in this manner, server device 102 may apply an exchange fee and/or a penalty fee.

At 510, server device 102 may receive a request for action from the user, such as a request to repay all or part of the UOU and/or a request to activate SWC. Server device 102 may continue to repeatedly monitor asset values within the portfolio until such a request is received.

At 512, server device 102 may evaluate the request. For example, repaying all or part of the UOU may be accomplished by sending the same amount of BRC lent on the inception of the loan from the portfolio back to the portfolio. As there is no reason to hold BRC in the portfolio, server device 102 may interpret a request including a repayment of BRC as a request to repay the liabilities.

In another example, the request may include a request to transfer assets from a portfolio which has non-zero liabilities. A true asset value for a locked asset may be different at a time of the locking and at a time of the unlocking, so server device 102 may evaluate the current value of any assets requested to be transferred.

In another example, the request may include a request to activate SWC. Server device 102 may determine whether the requested amount of SWC for activation is available and/or applicable to the current value within the portfolio.

At 514, after the evaluation determines how an action may be processed, server device 102 may process the action. If the action is not available (e.g., assets cannot be transferred or SWC cannot be activated), server device 102 may notify the user. Otherwise, server device 102 may process the requested action.

If the request is a request to repay liabilities, server device 102 may direct BRCs that are paid against the UOU's fees to a stability pool and burn the BRCs that are paid against the principal of the UOU. If the principal is fully paid, server device 102 may free up the assets in the portfolio. Paying back BRC may reduce the liabilities against the specific portfolio. For example, server device 102 may record a new entry in the blockchain smart contract indicating that the assets have been released to the user.

Similarly, if the request is a request to transfer specific assets, and server device 102 has indicated that there is enough value in the portfolio to allow those assets to be released, server device 102 may record a new entry in the blockchain smart contract indicating that the assets have been released to the user or transferred to the party indicated in the transfer request, for example.

Some requests may be requests to activate SWC. For example, fees charged by server device 102 (e.g., exchange fees, membership fees, loan fees, etc.) may be waived by activating SWC. The discount value may be measured by BRC/Month and may be calculated by Total fees in the economy/Total SWC activated in the economy*discount factor (e.g., 0.5, which means that 50% of the liabilities can be waived at any given time). Server device 102 may calculate total SWC activated and total fees by averaging 24-hour window amounts, for example, meaning that the discount value of SWC may change on a daily basis. Once SWCs are activated in order to waive fees, server device 102 may lock the activated SWC in the journal, rendering it unusable for any other purpose while locked. Locking SWC may allow users to increase their collateralization ratio by up to 10% in some embodiments. For reducing general fees (exchange fees, membership fees), the user may activate SWC that are held in the user's wallet. For loan fees reduction, the user may waive fees by sending an equivalent amount of SWC to the portfolio and activate them.

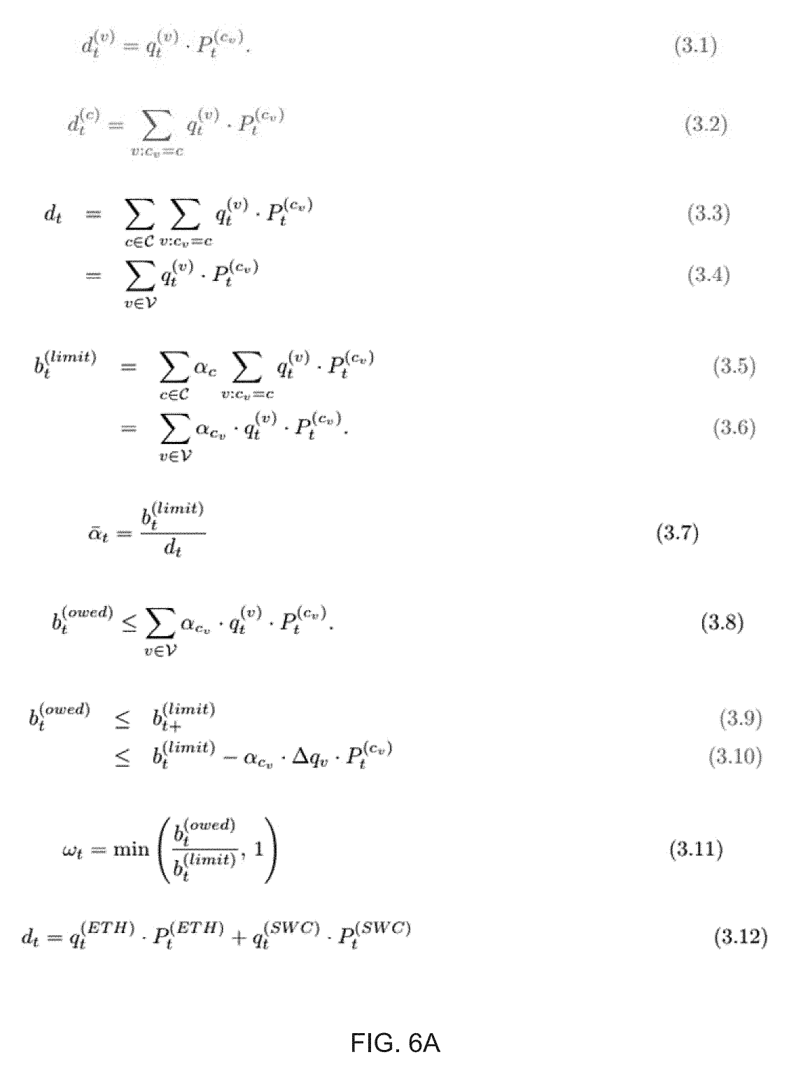

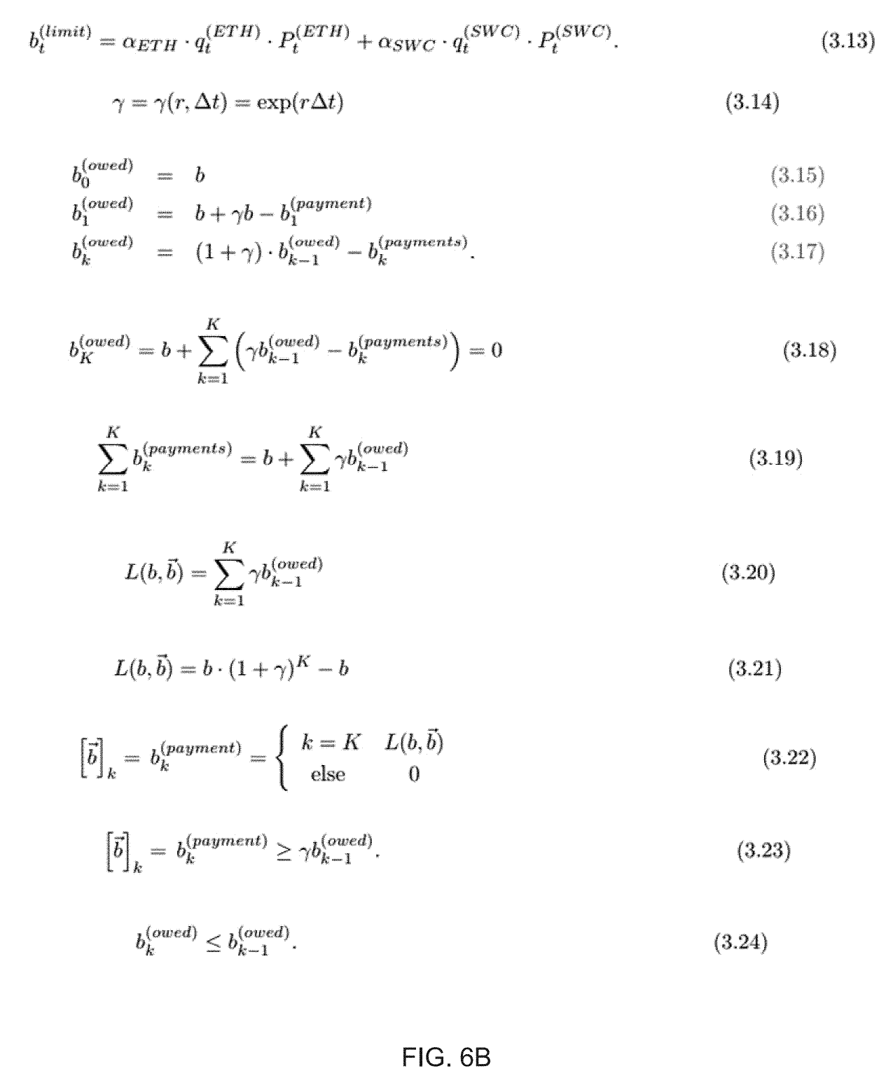

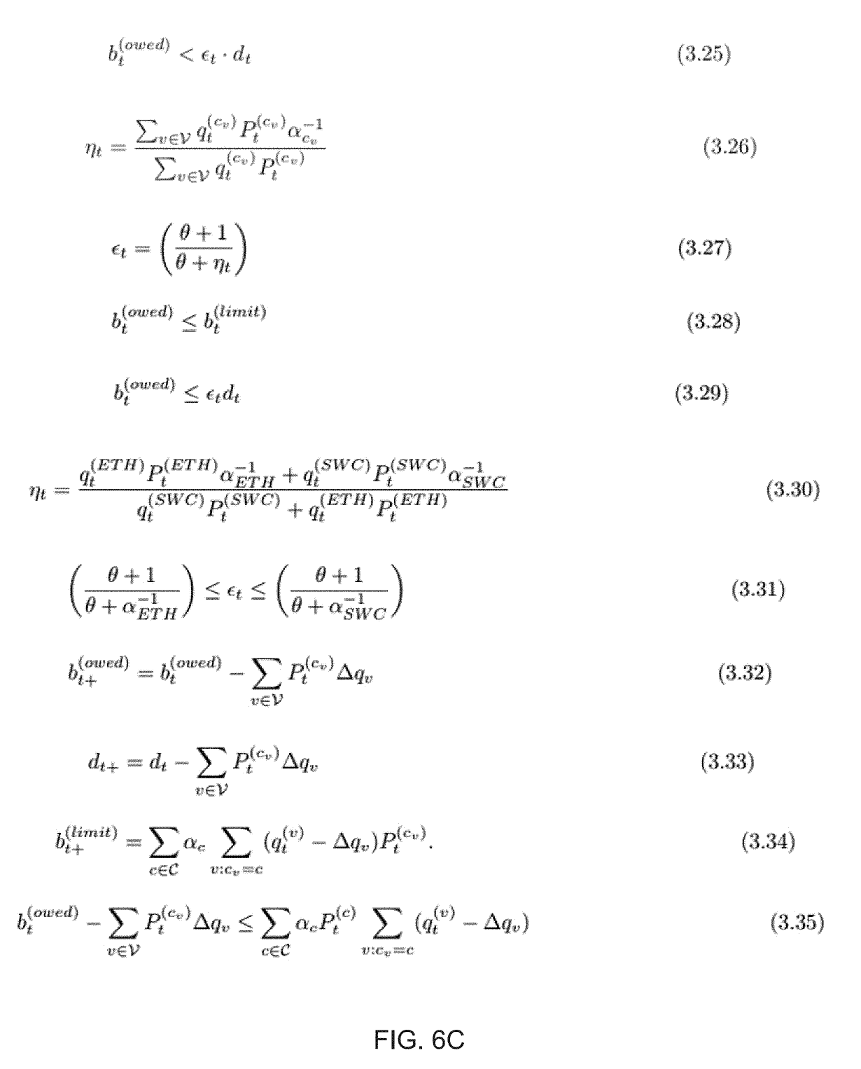

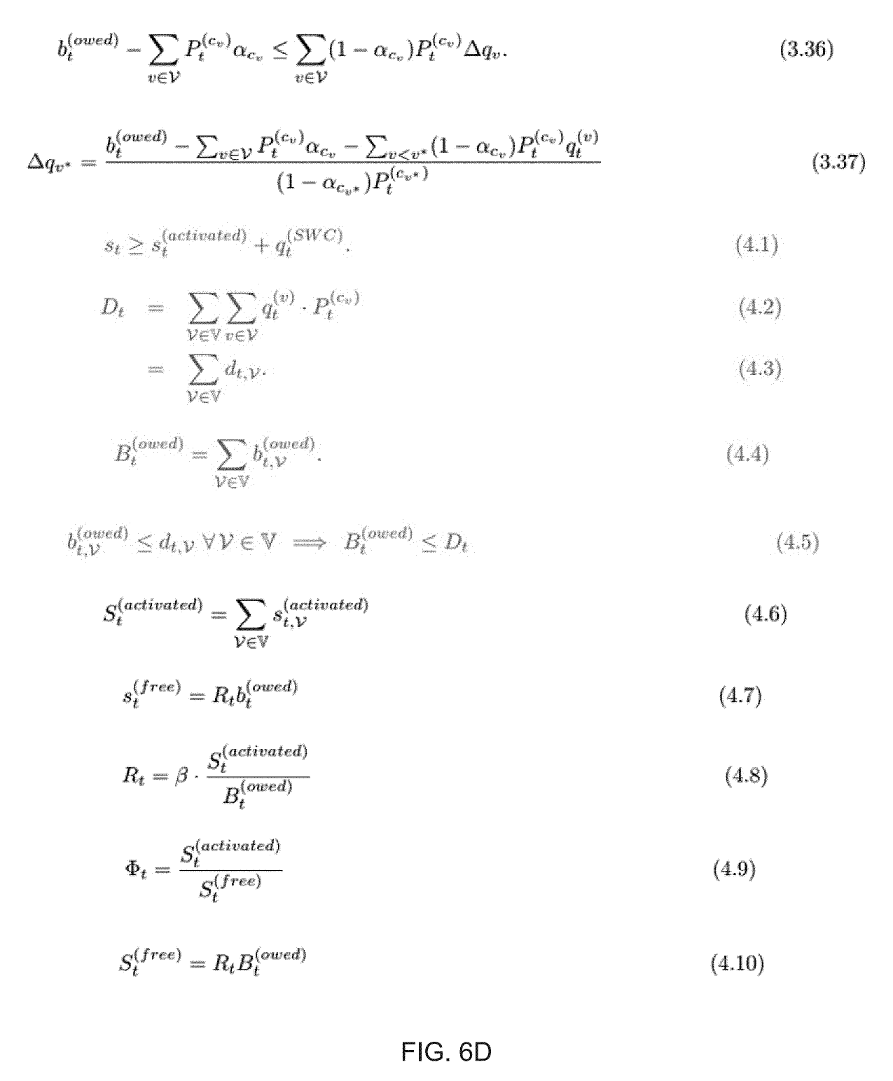

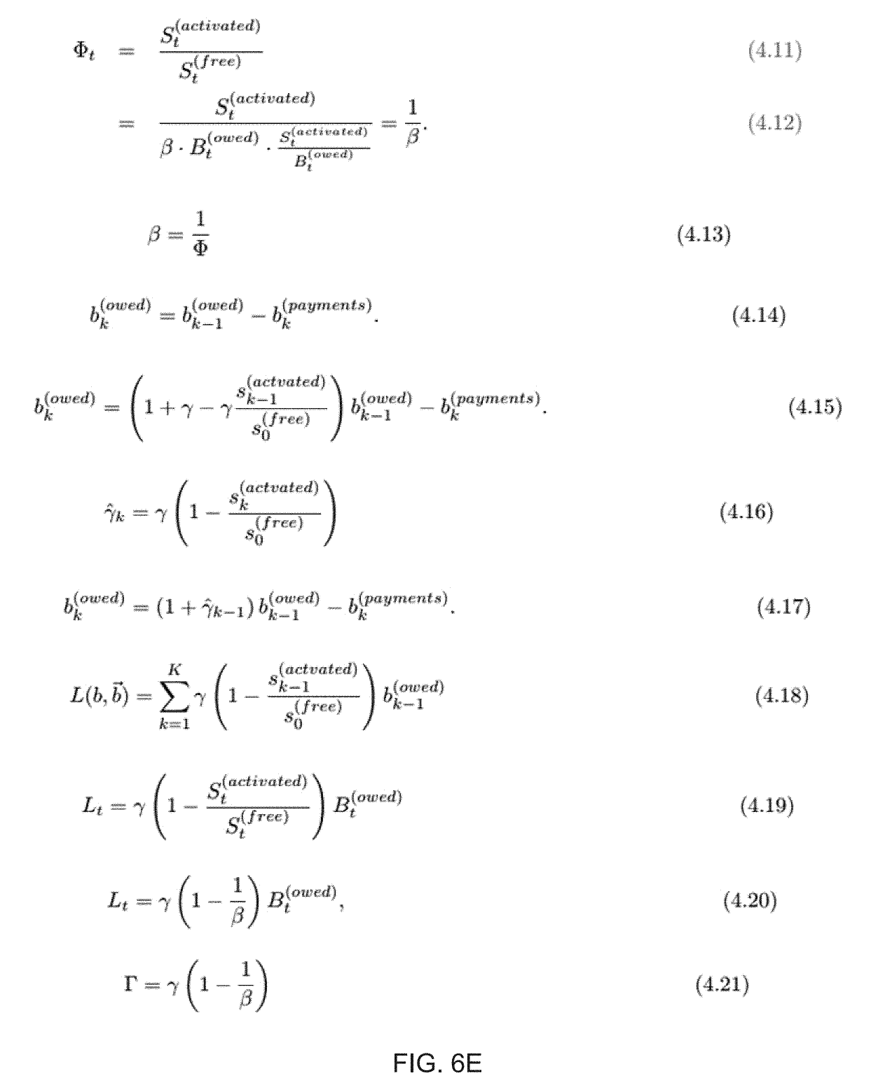

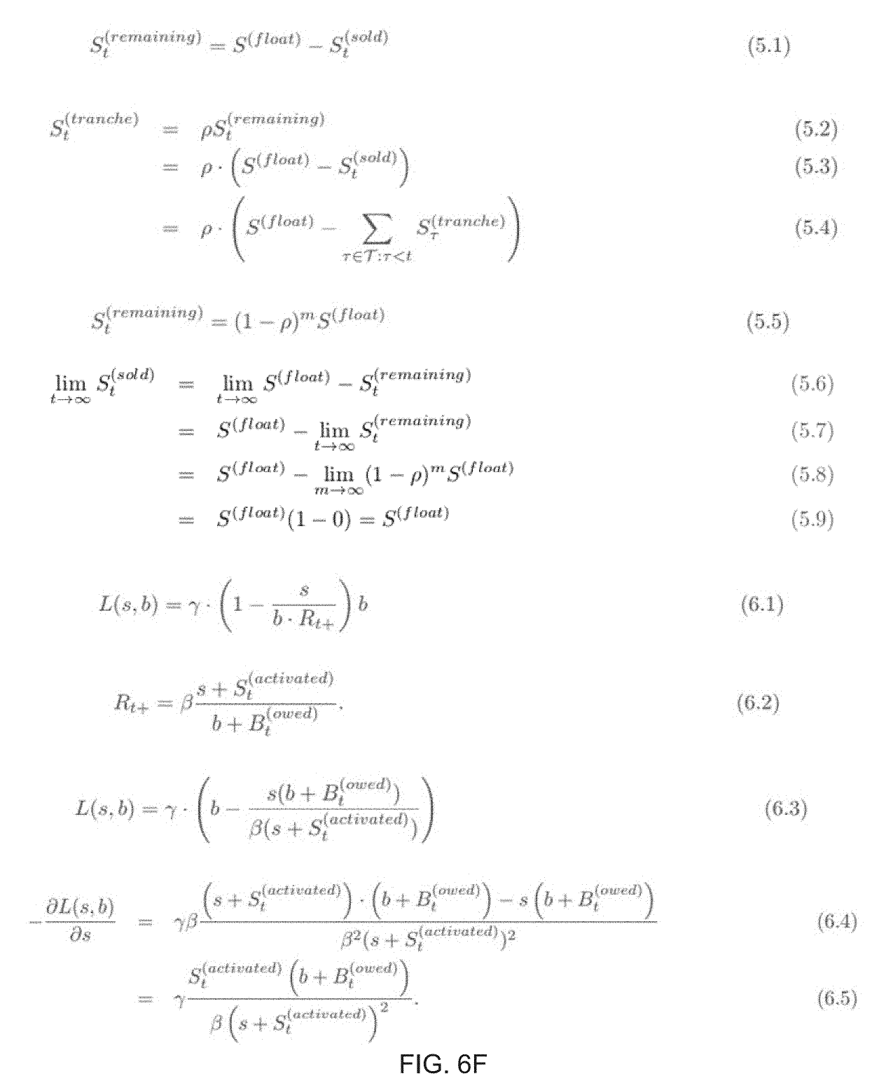

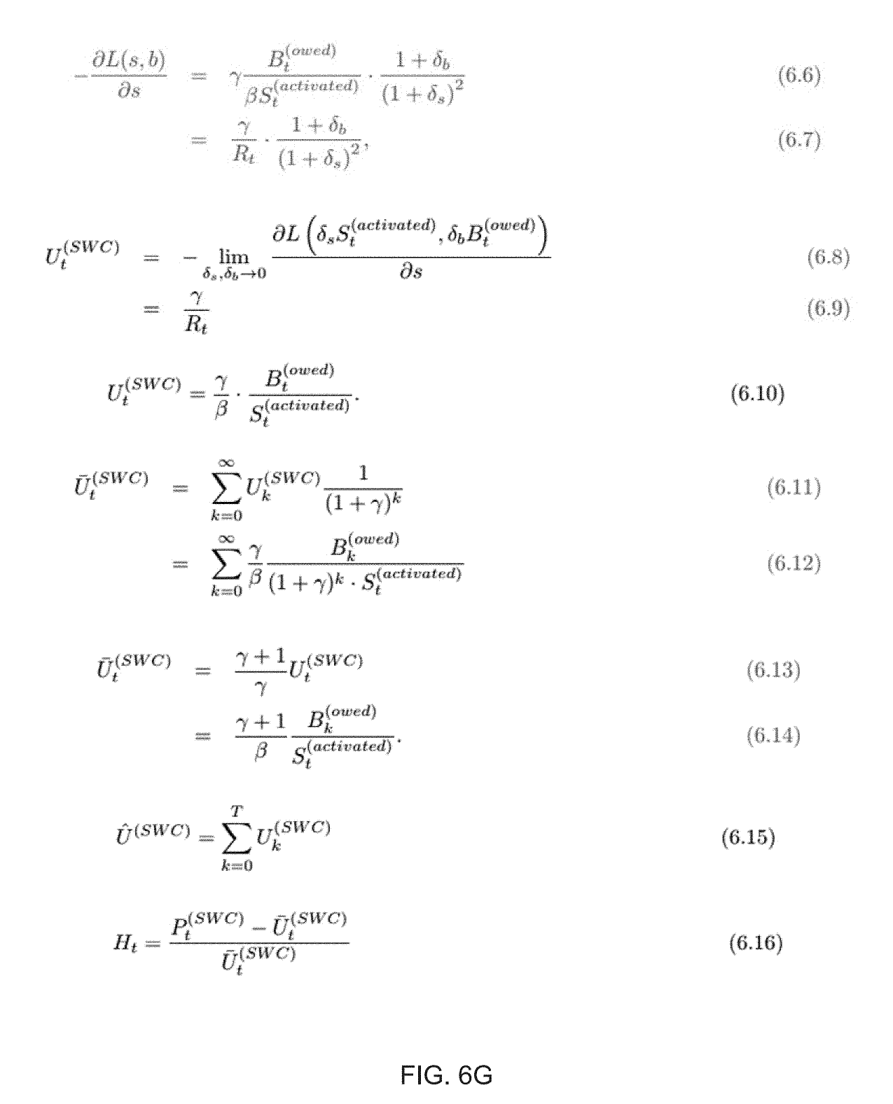

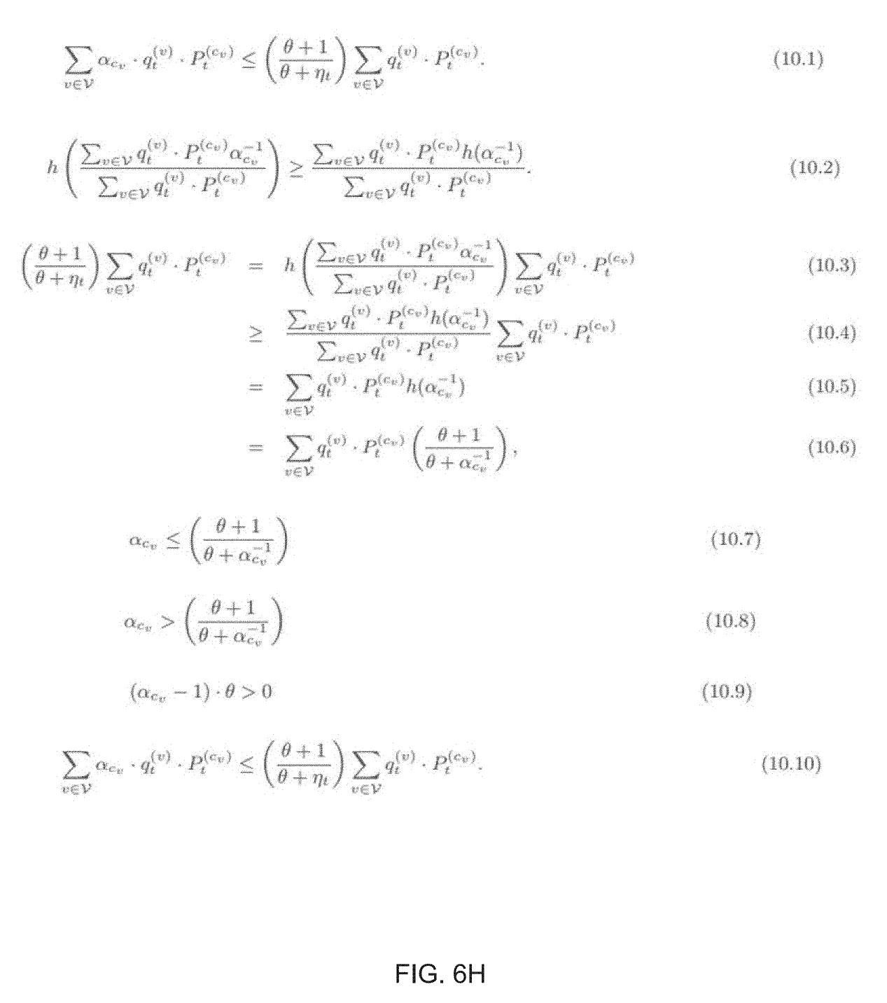

FIGS. 6A-6H show a plurality of mathematical equations related to an economic model for the systems and methods of FIGS. 1-5 according to an embodiment of the present disclosure. Along with the following discussion, these equations may provide mathematical specifications for an example liquidity protocol for asset management as described herein. The following liquidity protocol is presented as an example only, and it will be apparent to persons skilled in the art that various parameters of the mathematical specifications may be changed while providing similar functionality.

The economic model makes reference to three currencies in the following example (though others may be used in other embodiments): the United States Dollar (USD) fiat currency, Bridgecoin (BRC), and Sweetcoin (SWC). In some places, when referring to collateral locked inside the liquidity system, the economic model may also refer to cryptocurrencies, such as Ethereum (ETH) and Bitcoin (BTC). Network-wide variables related to these currencies will be captured in equations using capital letters D for USD, B for BRC, S for SWC, and E for ETH and other cryptoassets. When referring to decision variables and computed values that are specific instances of loans provided by the liquidity protocol rather than to network aggregates, the lowercase letters d, b, s and e will be used, respectively.

The currencies may exist in different states. For example, Sweetcoin can be activated to reduce the fees associated with borrowing Bridgecoin, as discussed above. The standard structure employed herein will be currencyₜᵢₘₑ^{(state)}. For example, the amount of Sweetcoin activated in the network at time t may be denoted Sₜ^{(activated)}. Additionally, for each collateral asset in a vault, the quantity of that collateral asset in its own unit may be denoted qₜ^{(collateral)}.

Another type of variable in the economic model is the price of each cryptocurrency relative to USD fiat. The common structure for these variables herein will be Pₜᵢₘₑ^{(currency)}. For example, the market price of Ethereum at time t may be denoted Pₜ^{(ETH)}. While the economics may be defined in continuous time, implementation may require an understanding of sampling, whereby continuous time is treated as discrete blocks of size Δt. A slight abuse of notation, Pₖ^{(ETH)}, may refer to the market price of Ethereum at a discretely defined time k. The time t referenced by k may be well-defined in context. The exact length of Δt may be an implementation detail without bearing on the formal structure of the system.

Vaults are defined as sets. Following standard mathematical notation, an arbitrary vault is denoted V. Every vault V may be made up of individual items or elements of collateral denoted v, the properties of which are outlined below. Complexity may arise when the Sweetbridge network-wide states are considered. These variables may be defined over the set of all vaults in the network. In order to handle the set of sets, the notation V∈V is introduced such that V is the set of all vaults V in the network. While the V set is time-varying as a result of users creating new vaults, reference to time is suppressed, and V may always be used to compute system parameters defined at the current time t.

Collateral is defined as an item of value that can be managed on blockchain. In mathematical terms, define the types of collateral accepted as a set C. For any c∈C, there is a market price Pₜ^{(C)} for all time t. In addition to having a market price determined outside of the system, every c∈C has a collateralization coefficient α_{c} that is set by the system and informed by the measured historic volatility of the market price Pₜ^{(C)}. α_{c} represents the limit of how much BRC may be borrowed against collateral c.

A collateral vault is a smart contract that takes control of an asset and issues Bridgecoin to the vault's owner. The smart contract may prevent transfer of the collateral or some portion of it as long as the issued Bridgecoin remains outstanding. A vault V is a set characterizing a portfolio of assets such that any v∈V must have a collateral type cv∈C. In cases of invoices and physical assets that are not fungible, there will be distinct items v, which share a common collateral type c. Thus the fiat value of each item v∈V is defined by equation 3.1. The value of any collateral type c is defined by equation 3.2. The total USD-denominated value can be expressed by either equation 3.3 or 3.4 for any vault V. Additionally, vault V has Bridgecoin borrowing power defined analogously; each item v∈V confers borrowing power α_{cv}*qₜ^{(v)}*Pₜ^{(cv)}. However, borrowing occurs against the whole portfolio of assets, not against a single asset, so the borrowing power of the vault is given by equation 3.5 and/or 3.6. From these values, it may be possible to compute an effective collateralization limit for the whole vault using equation 3.7, which will vary in time for vaults with non-zero quantities of more than one type of collateral; in case of one collateral type ⁻αₜ=α_{c} for that one type c. In general, the effective collateralization limit is a vault-specific metric equal to a fiat-value-weighted-average of the collateralization coefficients for the supported collateral types c∈C. Well-diversified vaults may see far less volatility in this metric.

Note that α_{c}<1 for all c∈C, thus at all times t, αₜ<1, which is equivalent to the borrowing power bₜ^{(limit)}<dₜ for any vault at any time. This may protect the system by limiting the probability that a member borrows the quantity bₜ^{(limit)} at time t only to have the vault value dₜ fall to dₜ<bₜ^{(limit)} at some future time τ. To further protect against loans entering this state, the asset vault smart contracts may be equipped with a sell line, as discussed further below.

When borrowing loans are taken against collateral vaults, the collateral within those vaults is no longer completely accessible by the vault owner. Due to the portfolio nature of vaults, it is not the currency itself that is locked, but rather a limitation is placed on the legal withdrawal actions allowable via the vault smart contract. For example, legal withdrawals from vaults may be defined by equation 3.6, where the current Bridgecoin liability bₜ^{(owed)} takes the place of the borrowing power according to equation 3.8. In other words, any attempt to withdraw a quantity of Δqᵥ for collateral v may only be allowed if equations 3.9 and 3.10 are satisfied, where t+ denotes the state variable at time t adjusted for the sale of Δqᵥ assets. At any time, the share of the assets in the vault that are locked is the ratio ωₜ, the debt to borrowing power given by equation 3.11, where the min operation indicates that all assets are locked if the debt is in excess of the borrowing power. When discussing a locked share of a vault containing a portfolio of diverse collateral assets, this percentage may be regarded as the percentage of the dollar-denominated value of these assets.

While the vault is in the fully locked state, assets may not be removed, but they may be applied directly against the outstanding debt as explained below. Should the value of the collateral in the vault continue to decline with respect to the liabilities, the sell line may trigger, preventing the vault from falling into a default state where the debt exceeds the asset values as explained below.

In an example implementation, the set V={ETH, SWC}, meaning that the only two elements in the set are collateral types Ethereum and Sweetcoin. Furthermore, since both Ethereum and Sweetcoin are fungible and divisible, it suffices to define each vault as having only having two elements e and s denoting Ethereum and Sweetcoin respectively, with qₜ^{(ETH)} denoting the full quantity of Ethereum deposited in the vault and qₜ^{(SWC)} denoting the full quantity of Sweetcoin deposited. Under this set of simplifying assumptions, equation 3.3 simplifies to equation 3.12, and equation 3.6 simplifies to equation 3.13.

The effective collateralization coefficient α̅t falls in the interval [α_{ETH}, α_{SWC}], achieving the lower limit for a vault entirely comprised of Ethereum and rising to reach the upper limit as the portfolio shifts toward Sweetcoin only. This metric is included as a means of showing users the benefits they receive by collateralizing Sweetcoin. These variations in at only occur as a result of the shifting weight of the fiat value of the vault's assets amongst collateral with different collateralization coefficients.

Loans against an asset vault may follow a standard continuously compounding interest model with the interest rate r defined as a global system parameter of the Sweetbridge economic system. Interest may be charged as an increase in the vault's liabilities over time. This excess in liability may constitute the fee users pay for the services provided by the system and can be offset through a discount model described below.

A loan taken against an asset vault may be repaid at the option of the vault holder within constraints put forth by the system. The general case of this loan and repayment can be stated in terms of discrete time periods Δt, and a total time period T equal to the length of the loan. By selecting a Δt, the interest rate r can be expressed as γ, the interest rate per time period Δt, which is generally more understandable to consumers. Liabilities grow by the fraction γ every time a period Δt passes. The value of γ may be computed from the underlying continuously compounding rate r and the time frame of choice Δt as given in equation 3.14, where exp(x) denotes the function of raising Euler's number e to the power x.

Denoting the period of the loan in intervals k and total number of such intervals K, the repayment schedule can be defined as bₜ^{(payment)} for k∈{1, . . . K}. The repayment plan is denoted as a vector b˜∈R₊^{K}. The choice of b denotes that payments are made in BRC. Using the k index for time, and t₀ as the timestamp of the initial loan, the mapping t=t₀+kΔt maps the discrete time view of the loan to continuous time. For a loan with principal b, the liabilities accrued accounting for payments made are given by the iteration through equations 3.15, 3.16, and 3.17. A valid payment schedule may have the property expressed in equation 3.18, and thus the total excess liabilities L(b,b̅) for borrowing b Bridgecoin and repaying according to b⁻ may be expressed as equation 3.20, computed by following the interest accrual trajectory over the in period t=t₀ to t=t₀+T using the discrete period k=0 to k=K. Note that this equation determines the liabilities for any given repayment schedule r), over any number K of periods of length Δt. If fees are estimated with one repayment schedule, and a different repayment schedule is realized, the actual excess liabilities are based on the true repayment schedule, not on the planned repayment schedule.

For example, consider a simple balloon payment plan supported with a single payment of all liabilities at time τ=t₀+KΔt. The total liabilities (denominated in Bridgecoin) are given by the compounding interest equation b·(1+γ)K and the excess liabilities resolve as shown in equation 3.21, derived from equation 3.20 with b̅ set to the balloon payment plant characterized elementwise as shown in equation 3.22, where the bracket notation [b̅]ₖ is used to indicate the k^{th} element of the vector b⁻.

Another example case may allow repayments over time but impose a restriction ensuring the debt cannot accumulate. Define a valid repayment schedule as any repayment schedule that does not increase the principal, i.e. at the very least, fees are repaid every period. This imposes an additional requirement on the repayment schedules b, which is defined for each individual interval Δt by equation 3.23. Enforcing this on a per-payment-period interval may ensure that the liabilities are not increasing, as given by equation 3.24. This is an alternative payment scheme from the balloon payment example, and it is, in fact, strictly inconsistent with the balloon payment scheme, because the balloon payment plan violates equation 3.23 at every time interval except the final time interval K. In some embodiments, a variety of payment schedules may be supported, with different rules.

The sell line is a system parameter in the economic system, defined by a global rule computed individually for each vault. The sell line may protect loans from going underwater in the sense that the total outstanding liabilities (denominated in Bridgecoin) against a vault might become greater than the USD-denominated value of the vault itself, which would remove the incentives for users to repay their loans. The sell line is a provision in the asset vault smart contract that may ensure that bₜ^{(owed)}<dₜ for that vault at any time t. Since bₜ^{(owed)} can vary in time due to the accrual of liabilities, and dₜ can vary due to changes in market price of the assets, it is possible that the vault might violate this invariant. Should this invariant be violated, the smart contact may sell some or all of the assets immediately, paying down the balance to achieve a valid state.

In practice, bₜ^{(owed)}<dₜ may be enforced with slack to account for volatility in price and the fact that the price of assets may continue to move after the event is triggered, but before the liquidation of assets is completed, rectifying the state of the vault. Therefore, the sell line condition may be defined by equation 3.25, where ∈ₜ=∈_{t,V} is a sell line function computed for each vault based on its riskiness. Having established the vault-specific context of this coefficient, we drop the extra subscript V referencing the vault. Likewise, the riskiness ηt=η_{t,V} of any vault V may be defined by equation 3.26, noting this quantity is a weighted average of the riskiness of each type of asset, α_{c}⁻¹=1/α_{c}. The greatest value lit can take for any vault is 1/αₘᵢₙ, and the smallest value is 1/αₘₐₓ where αₘᵢₙ=min_{c}∈Cα_{c} and αₘₐₓ=max_{c}∈Cα_{c}.

The sell line function can then be given by equation 3.27, where θ is a shape parameter. Recognizing that ηₜ⁻¹ is analogous to a portfolio-level collateralization coefficient, it is possible to explore choices and select a shape parameter.

It may be necessary to ensure that the parameter ∈ₜ computed according to equation guarantees that the sell line criteria is always stronger than the loan initialization criteria. That is to say, any vault satisfying equation 3.28, where bₜ^{(limit)} is defined in equation 3.6, also satisfies equation 3.29. It may suffice to assert equation 3.28 to enforce equation 3.29 as long as θ>0.

Theorem 1 may be given as any vault V satisfying the valid new loan condition defined in equation 3.28 will always satisfy the sell line condition in equation 3.29 when the vault-dependent sell line is set using equation 3.27, where shape parameter θ is selected such that θ>0, and the risk rating of the vault is lit as defined by equation 3.8. Proof is given below. Furthermore, any withdrawals of collateral that would violate 3.28 may be disallowed, further guaranteeing that withdrawals cannot trigger the sell line.

The MVP implementation of the asset vaults may only have Ethereum and Sweetcoin as collateral, so the sell line equations simplify to represent a weighted average of the risk levels associated with these assets. Given collateralization coefficients α_{ETH} and α_{SWC}, the risk value for any vault is given by equation 3.30, which can be interpreted as a fiat-denominated value weighted average of the risk factors. The sell line can fall anywhere in the interval given by equation 3.31, achieving the lower limit when the vault only contains Ethereum and achieving the upper limit for a vault only containing Sweetcoin. This holds because equation 3.27 is monotonically decreasing in the risk factor ηt defined in equation 3.8, and the risk coefficients are set such that α_{SWC}⁻¹<α_{ETH}⁻¹. Note that the relationship proven in Theorem 1 can be checked in the MVP case by comparing the effective collateralization α̅ₜ and sell line ∈ₜ for any ratio of Ethereum to Sweetcoin in the vault.

Validating the state of a vault with respect to the sell line requires that each oracle establish the current market price Pₜ^{(C)} for each type of collateral c in the vault, and the current fiat value of the vault, dₜ is computed according to equation (3.3). If bₜ^{(owed)}<∈ₜdₜ, the vault is in a valid state and no further action is required. However, if bₜ^{(owed)}≥∈ₜdₜ, then the vault is in an invalid state, and corrective action is triggered. At this point, it may not be sufficient simply to cross the sell line, because this could result in repeatedly triggering and correcting over very short periods of time. Instead, the corrective logic may force the vault into a valid state for a new loan in accordance with equation 3.28. Define the correction to be Δqᵥ for each v in the vault. This correction may be treated as happening instantaneously at time t, so the update is accounted for using the notation t and t+ denoting the prior and posterior states, respectively. Specifically, the amount owed prior to the correction is bₜ^{(owed)}, and the amount owed immediately after the correction is given by equation 3.32, but in selling these assets the value of the vault dₜ has been changed to the value given by equation 3.33, and the borrowing power against that vault has become that given by equation 3.34. Thus, to return the vault to a valid state, the values Δqv may be required to satisfy the linear inequality bₜ₊^{(owed)}<bₜ₊^{(limit)}, which may be expanded as shown in equation 3.35 and may be further simplified to equation 3.36.

Observing that equation 3.36 is a linear inequality constraint in the decision variable Δqᵥ, there may be an infinite family of valid solutions. This family of solutions can be reduced to a single solution by a user-specified liquidation rule set at the time of the original loan. Candidate liquidation rules may include any collateral preference scheme whereby the user ranks collateral items v in some order, and the smart contract liquidates the assets in the order specified. The quantities Δqᵥ required can be precomputed by setting Δqᵥ=qₜ^{(v)} for each v in the ranked order until equation 3.36 is satisfied. Furthermore, the collateral v* that crosses the threshold may be partially liquidated according to equation 3.37, where v<v* indicates collateral items v ranked before v*.

It may be impractical for the user to choose a ranking at the time the sell line is triggered, so preferences may be set in advance. In addition to user preselected ranking for the preferential liquidation scheme, the system may determine the ranking at the time of the liquidation using ranking oracles that compute rankings based on user prespecified schemes. Suggested schemes may include most depreciated assets liquidated first, most appreciated assets liquidated first, or lowest growth rate assets liquidated first. This method for returning vaults to valid states may not care what ranking is used, so ranking scheme options may be determined as part of product requirements.

While the sell line is a network protection mechanism that prevents vaults from entering a state of default, a proactive user may wish to pay down debts by directly cashing in collateral. Functionally, this user action may have the same inputs, outputs and requirements as the sell line. The prior state of the vault is defined by quantities of each asset qₜ^{(v)} and their respective values Pₜ^{(cv)}. At any time, a user could choose to cash in some collateral to pay down the balance by setting Δqv for any v∈V, as long as the criteria in equation 3.36 are met. This may enable a use case for appreciating assets, wherein a user could borrow a quarter of the value of an asset, and if the market price of the asset doubles, the loan could be paid off directly by allowing a smart contract to liquidate ⅛th of the collateral rendering the loan repaid. In the opposite case, a user who borrows against a quarter of the value of an asset and experiences the market price of that asset diminish by half could look to liquidate half of that asset to render the loan repaid.

To simplify an arbitrage mechanism described below, a variant of user-triggered asset sales may be based on the market price of Bridgecoin. Consider a situation in which intermittently P^{(BRC)}<1. Users with outstanding loans may be incentivized to lock in USD-denominated profits by repurchasing Bridgecoin under such market conditions and repaying their loans. Indeed, this behavior is one that would drive the price of Bridgecoin back towards par. Automated Bridgecoin repurchasing by users may instruct the system to trigger a collateral sale based on the price of Bridgecoin on the market, as reported by appropriate oracles, making this dynamic automated.

In a direct collateral purchase, the goal may be to enable users to use Bridgecoin to directly purchase collateral into a vault as long as the state of the vault is valid after such a purchase. Example: if α_{ETH}=0.5, P^{(ETH)}=100 and user has 500 Bridgecoin, then the user may pay this Bridgecoin to acquire a vault where qᵥ^{(ETH)}=10, b^{(owed)}=500. This is economically equivalent to a user paying 1000 BRC for 10 ETH, depositing 10 ETH into a vault and withdrawing 500 BRC from this vault. There may be a range of valid vaults that can be acquired. For example, for 700 BRC, a user may acquire a vault where qᵥ^{(ETH)}=10 and b^{(owed)}=300.

In order to adequately measure and control the economy implemented by the liquidity protocol, a limit may be placed on the total amount of Bridgecoin borrowed network-wide. This value may be set at the discretion of a human operator and/or may be designed as a function related to the treasury, collateral, and other measurable system variables, so that the economic system stability is reliably maintained.

Sweetcoin may be used as a coupon that gives their holders rights to certain discounts and services. From the outset, Sweetcoin may be created in limited supply and released indefinitely via a convergent drip mechanism described below. Fees charged for UOU loans may be represented as excess repayment liabilities. At user's option, Sweetcoin may be used to offset these fees. To do this, a user may activate Sweetcoin in her vault. The Sweetcoin associated with a vault at any time is denoted Sₜ. That Sweetcoin may be used as a collateral type, in which case qₜ^{(SWC)} denotes the quantity locked as collateral within the vault at the current time t. This usage may be distinct from activating the Sweetcoin, denoted Sₜ^{(activated)}. The values Sₜ, . . . , qₜ^{(SWC)}, and Sₜ^{(activated)} may be well-defined within the context of a specific vault V. The total Sweetcoin associated with the vault Sₜ=S_{t,V}, the quantity of Sweetcoin collateralized in the vault qₜ^{(SWC)}=q_{t,V}^{(SWC)}, and Sweetcoin activated Sₜ^{(activated)}=s_{t,V}^{(activated)} are used when a direct reference to the vault is required. Suppressing the V, for any such vault, equation 4.1 may hold.

That is to say, activating Sweetcoin in a vault may be distinct from using it as collateral alongside other valuable assets. When used as collateral, Sweetcoin may act as any other asset, with its own collateralization coefficient and a real-time price oracle. This equation enforces the fact that a quantity of Sweetcoin may be activated, locked as collateral, or neither, but the same Sweetcoin cannot be used in both capacities simultaneously.

The effect of activating Sweetcoin to offset liabilities may be defined with respect to the liabilities outlined above. The fraction of liabilities that are offset per Sweetcoin activated may be determined by the total Sweetcoin locked in the network and the total fiat-denominated value of all locked collateral. The total collateral value in the network is given by equations 4.2 and 4.3. The total liabilities in the system may be computed by equation 4.4 The vault smart contracts may be equipped with sell lines ensuring that the individual vaults have the property expressed in equation 4.5, ensuring that the total Bridgecoin owed within the economy remains well supported. The total Sweetcoin activated in the network is given by equation 4.6, where V is the set of all vaults V current in the network. The amount of Sweetcoin that would eliminate all liabilities for a given vault is given by equation 4.7, where Rₜ is network state dependent activation rate defined by equation 4.8, with system parameter β set to control the sensitivity of the system to fluctuations in the network state. The defining property of β may be the fact that reducing β proportionally reduces the amount of Sweetcoin that needs to be activated to achieve an interest-free loan.

As a consequence of its role in activation rate defined in equation 4.8, the parameter β may directly define the share of the excess liabilities network-wide that can be offset through Sweetcoin activation. The global share of liabilities offset Φt is defined as shown in equation 4.9, where the global variable Sₜ^{(free)} is the total Sweetcoin that would need to be activated to offset all liabilities currently in the network defined by equation 4.10 in accordance with equation 4.8, and the observation that the discount is a linear function. Substituting the definition of Rₜ yields equations 4.11 and 4.12.

By design the quantity Φt is not a free variable at all but rather a time invariant control of the system tied directly back to the choice of β. Given a preferred value for the global share of the liabilities being offset at any time, Φ, the parameter β may be set as shown in equation 4.13, and in the live system, the actual value of Φt=Sₜ^{(activated)}/Sₜ^{(free)} can be computed for every block, and comparing Φt to the value 1/β may provide a measure of health of the network.

Consider a vault V with borrowing power bₜ^{(limit)}, assuming the user borrows the limit, denote bₜ=bₜ^{(owed)}=bₜ^{(limit)}. The user also has sufficient Sweetcoin available to set Sₜ^{(activated)}=Sₜ^{(free)}, in accordance with equation 4.7. This alters the liabilities accrued as long as the Sweetcoin remains activated; the liabilities update equation 3.17 becomes simply equation 4.14.

It is assumed that t for the purpose of determining the Sₜ^{(free)} for a specific vault V is set to the last time the vault state was modified via user interaction. t=t₀. In doing so, the discrete time index k with k=0 for time t=t₀ may be used for considering the more general case where Sₜ^{(activated)}=Sₜ₀^{(free)}, equivalently expressed as Sₖ^{(activated)}<S₀^{(free)}. Sufficient Sweetcoin has not been activated to completely offset the excess liabilities, but a linear discount is still applied resulting in the liability update equation 4.15. One can think of this as defining a discounted interest rate given by equation 4.16, allowing re-expression of the fees with the context dependent interest rate ̂γk according to equation 4.17. Both equations 4.15 and 4.17 resolve to equation 3.17 when no Sweetcoin is activated to offset the fees, and to equation 4.14 when Sweetcoin is activated as determined by equation 4.7 computed at time t=t₀, representing the last time the vault state was modified. So for any particular repayment plan the excess liabilities are given by equation 4.18, where bₖ^{(owed)} for each k in the sequence is given by equation 4.15.

As a consequence of the global limits in fee elimination, it is possible to directly derive the revenue generation of the liquidity protocol in Bridgecoin per payment period from t to t+Δt as a function of the total outstanding liabilities bₜ^{(owed)}. Since every loan has the same base interest rate γ for each period Δt, and the discount function for activating Sweetcoin is linear, it follows that the total new liabilities generated are given by equation 4.19, and applying equation 4.12, this is simply equation 4.20, allowing the definition of a new quantity, the global revenue generator coefficient given by equation 4.21, which determines the expected Bridgecoin revenue from vaults per Bridgecoin of liabilities outstanding. Knowledge of this relation allows practical reasoning about the required interest rate γ and the fraction of liabilities that can be offset 1/β, necessary to support the operation of the network and stability incentives described below. This relation justifies the expectation that efficiencies of scale will emerge, allowing the interest γ to be reduced as the scale of the network grows, measured in total concurrent outstanding debt.

There may be a total amount of S^{(total)} Sweetcoin created initially. A total public float of SWC S^{(float)} is defined as all SWC allocated for public sale. The system may hold a continuous crowdsale in order to create a supply of liquid fiat currency to provide free Bridgecoin exchange services to users. Additionally, the crowdsale may incentivize users to generate early deposits of collateral into the asset vaults. In order to purchase Sweetcoin, users may acquire Bridgecoin either through a direct at-par purchase as described below, or by depositing collateral into their asset vault; users may deposit Bridgecoin into a purchase queue smart contract; and periodic releases of Sweetcoin may execute against the orders in the purchase queue. Execution priority may be given to the orders at the front of the queue. The price of the Sweetcoin sold against the purchase queue may be beneficial to users in the queue as compared to purchasing Sweetcoin on the open market.

The crowdsale may proceed over an indefinite period of time in small tranches. Since the total Sweetcoin to be released for public sale is S^{(float)}, the remaining quantity for sale can be related to the total sold as shown in equation 5.1, where Sₜ^{(sold)}=Σ_{τ∈Tt}Sₜ^{(tranche)}, and τₜ is the set containing all the distinct times τ earlier than t for which tranches were released.

The size of each release tranche S^{(tranche)} may be determined as a percentage ρ<<1 of the remaining float as given in equations 5.1, 5.2, and 5.3. By defining p as a share of the remaining public float, it may be ensured that tranche releases can continue indefinitely without fully depleting S^{(float)}. At any time t, the remaining float may be given by equation 5.5, where m=|Tₜ|, the cardinality of the set Tₜ which also is the number of tranches passed. It is further evident that as t−>∞, and if the tranche releases continue, then m=|Tₜ|−>∞ and the equations 5.6, 5.7, 5.8, and 5.9 hold, thus converging to the intended total of Sweetcoin sold at the exponential rate (1−ρ). In some embodiments, ρ=0.01, and the exponential decay rate is 0.99, which is equivalent to selling half of the remaining public float supply every 69 tranches.

The utility value of Sweetcoin Uₜ^{(SWC)} may be defined as price type variable derived from the Bridgecoin liabilities offset per one Sweetcoin activated per period of time. Uₜ^{(SWC)} may have the units of dollars per Sweetcoin per period of time and may account for savings realized by a user of the liquidity protocol borrowing via the vault contract.

Previously, the liabilities associated with Bridgecoin loans were analyzed with respect to the amount being borrowed, bₜ^{(owed)}. In this section, attention is returned to the liabilities equations, but the focus is shifted to the role of Sweetcoin. First, the liabilities per repayment period Δt are restated in terms of the decision to activate a quantity of Sweetcoin s and a quantity being borrowed b, in equation 6.1, where Rₜ₊ denotes the activation rate defined in equation 4.) accounting for the additional Sweetcoin being activated as shown in equation 6.2. Substituting and simplifying gives equation 6.3, which represents the liabilities incurred in the period Δt for a loan with decision variable b for Bridgecoin borrowed and s for Sweetcoin activated. The financial utility per Sweetcoin activated is the negative of the rate of liability reduction per unit Sweetcoin activated as shown in equations 6.4 and 6.5.

Equation 6.5 indicates that in the general case the utility of activating Sweetcoin is a function of the amount of Sweetcoin being activated and the amount of Bridgecoin being borrowed. Consider the case in which these quantities are defined as fractions of the network totals, s=δₛSₜ^{(activated)} and b=δ_{b}Bₜ^{(owed)}, as shown in equations 6.6 and 6.7, indicating that the borrower's share of the Sweetcoin activated is a more powerful factor than the share of the total Bridgecoin borrowed. This may be meaningful for early adopters taking on non-trivial shares of Bₜ^{(owed)} and Sₜ^{(activated)}. However, in practice b<<Bₜ^{(owed)} and s<<Sₜ^{(activated)} as soon as the network gains traction. In this case δs and δb rapidly approach zero. Therefore, define Uₜ^{(SWC)} in terms of the steady state according to equations 6.8 and 6.9, indicating the utility of Sweetcoin is directly proportional to the interest rate and inversely proportional to the Sweetcoin activation rate Rₜ, defined above. The utility of Sweetcoin can be directly represented in terms of the Sweetcoin activated and Bridgecoin debt as shown in equation 6.10.

The utility value of Sweetcoin Uₜ^{(SWC)} is defined per time interval. This section seeks an appropriate estimation of Sweetcoin fair value at the present moment. For example, what would it be worth for a user today to own the right of receiving the future discounts enabled by owning a unit of Sweetcoin?

A first approach may address the time-discounted value of money. The basis for this approach is to calculate the present value one will need to own so as to receive the equivalent amount of services from the system in the future. In other words, the question may be framed as how much Bridgecoin one needs to have today to pay the Sweetbridge UOU fees equivalent to the amount cancelled by the system over the infinite time horizon.

The discount rate used in this calculation is the rate of return on a reference investment. For example, the reference investment is given by the discount accounts that will have the rate of return equal on average to the asset vault interest rate. We will term this value the “discount value” of Sweetcoin, defined as Ūₜ^{(SWC)}, an expectation of savings over time discounted to the present moment based on the interest rate γ, as shown in equations 6.11 and 6.12, where k is the discrete time index; k=0 at time t=t₀ and each successive k corresponds to t=t₀+kΔt. In the general case, the sum remains open form because the value Uₖ^{(SWC)} is expected to vary in time. Breaking the Uₜ^{(SWC)} out using the definition, it is clear that Uₜ^{(SWC)} can be expected to grow with traction in the network as defined by increasing Bₜ^{(owed)} in time, because the Sₜ^{(activated)} is bounded by the Sweetcoin supply.

To create a practical Uₜ^{(SWC)}, a conservative simplifying assumption is applied: Uₖ^{(SWC)}=Uₜ^{(SWC)} for all k, effectively treating the current Uₜ^{(SWC)} as if it were constant. Accounting for this assumption, the infinite sum converges, resolving to equations 6.13 and 6.14. Observing that the total Sweetcoin available in the network is bounded in accordance with the convergent drip crowdsale, it can be inferred that the value Uₜ^{(SWC)}, and consequently Uₜ^{(SWC)}, will rise as the network gains traction. In this case, the total amount Bₜ^{(owed)} is our notion of traction, and success of the platform will see the total debt Bₜ^{(owed)}, the total dollar value of all collateral Dₜ, and the fiat reserves of the system (described below) all rising in appropriate proportions but without explicit bounds.

An alternative model for calculating fair value is given by comparing the discounts provided by Sweetcoin to rent charged on commercial real estate. A real estate investment is an active investment with two income-generating components: rent value charged to tenants over time, and resale value. Commercial real estate prices may be calculated as a sum of rent over a finite period of time without applying time discounts and under reasonable rent increase assumptions. The time horizon and the growth assumptions may differ by market. In many cases, the time horizon ranges between five and ten years. Applying this methodology to Sweetcoin may yield the “rent value” of Sweetcoin over time horizon T as equation 6.15.

The two models may converge to the same value, assuming a 5% interest rate to calculate Ū^{(SWC)} and taking the time horizon of five years and growth assumptions on U^{(SWC)} of 77% year over year or seven years with growth assumption of 36%. This tells us that the time-discounted valuation model lands us well in the vicinity of the values given by the real estate model under reasonable growth assumptions in an early stage network.

This discussion uses Ū^{(SWC)} to designate the fair value, with the understanding that as new data emerges, the model may be corrected to reflect actual market behavior. The fair value of Sweetcoin with respect to real utilization of the services provided may be based on the economic analysis of live network data. Fundamentally, the fair value is a mathematical interpretation of the discounts provided through the activation of Sweetcoin for use of the platform. This discount mechanism aligns incentives between Sweetcoin holders and the platform by showing mathematical alignment between demand on the platform and the implied value of the utility the platform provides.

As with all token economies, the market price of Sweetcoin may be influenced by speculation. To a moderate extent, speculation can be good because it indicates a belief by the market that the token will appreciate. Nonetheless, hype often becomes a feedforward process that can ultimately undermine the perception of legitimate utility. The system may leverage utility metric Sₜ^{(SWC)} in order to track meaningful measure of hype within its economy, Hₜ. The hype metric is defined by equation 6.16, which may be the percent error of the market price against the fair value. Due to the arbitrage opportunity discussed above, it is expected that Hₜ may remain positive on average and recover from negative values rather quickly, limited only by liquidity in the market. An exception to this would be an expectation on part of the users that the utilization of the platform will diminish over time.

In other cases, Hₜ may be examined empirically to determine whether the hype itself is increasing or decreasing over time. Decreasing hype, converging to Hₜ=1 on average, would represent the market coming to consensus around the belief that the time-weighted expected utility value Ūₜ^{(SWC)} represents the fair value of Sweetcoin. A consistent average hype value greater than one would indicate that the market expects Sweetcoin to appreciate at a more or less continuous rate, and it would be interesting to use analytics to observe how long a time interval t−τ should be expected before Ūτ^{(SWC)}=Pₜ^{(SWC)} where τ>t. Finally and arguably the dangerous case, the hype may be growing in time; should Hₜ be observed to grow steadily in t, there is a risk that speculation will so completely swamp utility as to undermine the functional value of the token. Should this be observed, action may be undertaken to counteract the destabilizing effects of irrational hype.

The following brief section provides a proof of Theorem 1. Any vault V satisfying the valid new loan condition defined in equation 3.28 will always satisfy the sell line condition in equation 3.29, when the vault-dependent sell line is set using equation 3.27, where shape parameter θ is selected such that θ>0, and the risk rating of the vault is ηₜ as defined by equation 3.8.

Proof: The statement of the theorem is equivalent to the claim of equation 10.1. The following argument demonstrates this claim working backwards from the righthand side expression. The critical point driving this argument is an application of Jensen's inequality applied to the definition of Et, which holds because function h(z)=(θ+1)/(θ+z) is concave for z>0 by design; the application of Jensen's inequality yields equation 10.2. Putting this inequality in place and simplifying gives equations 10.3, 10.4, 10.5, and 10.6. Beyond the application of Jensen's inequality, all of the above is substitution of the aforementioned definitions. To proceed now, it is necessary to show equation 10.7, which is proved through contradiction. Suppose the opposite claim of equation 10.8. Then it follows through simple algebra that equation 10.9 holds, which contradicts the definitions as all α_{cv}<1 and θ>0. Now inequality 10.7 is applied to 10.6 to yield equation 10.10.

While various embodiments have been described above, it should be understood that they have been presented by way of example and not limitation. It will be apparent to persons skilled in the relevant art(s) that various changes in form and detail can be made therein without departing from the spirit and scope. In fact, after reading the above description, it will be apparent to one skilled in the relevant art(s) how to implement alternative embodiments. For example, other steps may be provided, or steps may be eliminated, from the described flows, and other components may be added to, or removed from, the described systems. Accordingly, other implementations are within the scope of the following claims.

In addition, it should be understood that any figures which highlight the functionality and advantages are presented for example purposes only. The disclosed methodology and system are each sufficiently flexible and configurable such that they may be utilized in ways other than that shown.

Although the term “at least one” may often be used in the specification, claims and drawings, the terms “a”, “an”, “the”, “said”, etc. also signify “at least one” or “the at least one” in the specification, claims and drawings.

Finally, it is the applicant's intent that only claims that include the express language “means for” or “step for” be interpreted under 35 U.S.C. 112(f). Claims that do not expressly include the phrase “means for” or “step for” are not to be interpreted under 35 U.S.C. 112(f).

What is claimed is:

1. A method comprising:
locking, with a processor, an asset in a blockchain-based database in communication with the processor, the locking comprising establishing a locked asset value for the asset and preventing exchange of the asset by an asset owner;
generating, with the processor, a loan value for the asset less than the locked asset value;
recording, with the processor, the loan value in the blockchain-based database; and
transmitting, with the processor, a loan asset having the loan value to the asset owner.

2. The method of claim 1, wherein a true asset value for the asset varies independently of the locked asset value.

3. The method of claim 1, further comprising:
receiving, with the processor, a payment equal to the loan value from the asset owner; and
unlocking, with the processor, the asset in the blockchain-based database, the unlocking comprising enabling exchange of the asset by the asset owner.

4. The method of claim 3, wherein a true asset value for the asset is different at a time of the locking and at a time of the unlocking.

5. The method of claim 1, further comprising determining, with the processor, the loan value.

6. The method of claim 5, wherein the determining comprises determining a market value for the asset and generating the loan value based on the market value, wherein the loan value is less than the market value.

7. The method of claim 5, wherein the determining comprises retrieving a previously determined loan value from the blockchain-based database.

8. The method of claim 1, further comprising:
establishing, with the processor, a sell line value for the asset;
determining, with the processor, that a true asset value for the asset is less than the sell line value;
determining, with the processor, an amount of the asset to sell based on a difference between the true asset value and the sell line value; and
reducing, with the processor, the locked asset value in the blockchain-based database by the amount.

9. The method of claim 1, further comprising generating, with the processor, the asset in the blockchain-based database from a digital token representing a real asset.

10. The method of claim 9, further comprising generating, with the processor, the digital token in the blockchain-based database.

11. The method of claim 1, further comprising generating, with the processor, a blockchain-based smart contract.

12. The method of claim 1, further comprising establishing, with the processor, a signed contract in the blockchain-based database.

13. The method of claim 12, wherein the establishing comprises generating a smart contract in the blockchain-based database from a received contract.

14. The method of claim 12, wherein the establishing comprises adding at least one received signature to a smart contract in the blockchain-based database.

15. A system comprising:
a blockchain-based database; and
a processor in communication with the blockchain-based database, the processor being configured to:
lock an asset in the blockchain-based database, the locking comprising establishing a locked asset value for the asset and preventing exchange of the asset by an asset owner;
generate a loan value for the asset less than the locked asset value;
record the loan value in the blockchain-based database; and
transmit a loan asset having the loan value to the asset owner.

16. The system of claim 15, wherein a true asset value for the asset varies independently of the locked asset value.

17. The system of claim 15, wherein the processor is further configured to: receive a payment equal to the loan value from the asset owner; and unlock the asset in the blockchain-based database, the unlocking comprising enabling exchange of the asset by the asset owner.

18. The system of claim 17, wherein a true asset value for the asset is different at a time of the locking and at a time of the unlocking.

19. The system of claim 15, wherein the processor is further configured to determine the loan value.

20. The system of claim 19, wherein the determining comprises determining a market value for the asset and generating the loan value based on the market value, wherein the loan value is less than the market value.

21. The system of claim 19, wherein the determining comprises retrieving a previously determined loan value from the blockchain-based database.

22. The system of claim 15, wherein the processor is further configured to:
establish a sell line value for the asset;
determine that a true asset value for the asset is less than the sell line value;
determine an amount of the asset to sell based on a difference between the true asset value and the sell line value; and
reduce the locked asset value in the blockchain-based database by the amount.

23. The system of claim 15, wherein the processor is further configured to generate the asset in the blockchain-based database from a digital token representing a real asset.

24. The system of claim 23, wherein the processor is further configured to generate the digital token in the blockchain-based database.

25. The system of claim 15, wherein the processor is further configured to generate a blockchain-based smart contract.

26. The system of claim 15, wherein the processor is further configured to establish a signed contract in the blockchain-based database.

27. The system of claim 26, wherein the establishing comprises generating a smart contract in the blockchain-based database from a received contract.

28. The system of claim 26, wherein the establishing comprises adding at least one received signature to a smart contract in the blockchain-based database.
